(19) United States
(12) Patent Application Publication
(10) Pub. No.: US 2006/0158113 A1
(43) Pub. Date: Jul. 20, 2006

(54) Plasma display panel and method of driving the same

(76) Inventors: Min Hur, Suwon-si (KR); Young-Do Choi, Suwon-si (KR); Jae-Rok Kim, Suwon-si (KR); Hyea-Weon Shin, Suwon-si (KR)

Correspondence Address: CHRISTIE, PARKER & HALE, LLP, PO BOX 7068, PASADENA, CA, 91109-7068, US

(21) Appl. No.: 11/301,789

(22) Filed: Dec. 12, 2005

(30) Foreign Application Priority Data
Jan. 20, 2005 (KR) 10-2005-0005288
Feb. 1, 2005 (KR) 10-2005-0009046
Feb. 15, 2005 (KR) 10-2005-0012292
Feb. 24, 2005 (KR) 10-2005-0015329

(51) Int. Cl. H01J 17/49; H01J 9/24

(52) U.S. Cl. 313/582; 313/585; 313/586; 445/24

(57) ABSTRACT

A plasma display panel adapted to reduce a discharge firing voltage and reset and address periods, thereby enhancing luminescence efficiency. The plasma display panel include first and second substrates facing each other with a predetermined gap in between. The gap is divided into a plurality of discharge cells where phosphor layers are formed. First and second electrodes alternately extend in a first direction between the substrates and further extend in a third direction from the first toward the second substrate. First and second address electrodes are located between the substrates and extend in a second direction intersecting the first direction. The address electrodes correspond to boundaries of the discharge cells located adjacent in the first direction and have protruding portions alternately protruding inside their respective discharge cells.

### CROSS-REFERENCE TO RELATED APPLICATIONS

This application claims priority to and the benefit of Korean Patent Applications No. 10-2005-0005288 filed on Jan. 20, 2005, No. 10-2005-0009046 filed on Feb. 1, 2005, No. 10-2005-0012292 filed on Feb. 15, 2005, and No. 10-2005-0015329 filed on Feb. 24, 2005 in the Korean Intellectual Property Office, the entire contents of all of which are incorporated herein by reference.

### BACKGROUND OF THE INVENTION

1. Field of the Invention

The present invention relates to a plasma display panel and a method of driving the same. More particularly, the present invention relates to a plasma display panel that can reduce a discharge firing voltage and reduce a reset period and an address period, thereby enhancing power of gray-scale representation, and a method of driving a plasma display panel.

2. Description of Related Art

Generally, a plasma display panel (PDP) has a three-electrode surface-discharge structure. The three-electrode surface-discharge structure of a PDP includes a substrate that has sustain electrodes and scan electrodes located on the same surface, and another substrate that is spaced away from the substrate including the sustain and scan electrodes, and has address electrodes extending in a direction intersecting the common direction of the sustain and scan electrodes. A discharge gas, for example xenon (Xe) or neon (Ne), is sealed between both substrates.

In this PDP, whether or not a discharge is generated is determined by a discharge between the scan electrodes and the address electrodes that are controlled independently. Then, images are realized by a sustain discharge between the sustain electrodes and the scan electrodes.

The PDP generates visible light by a glow discharge through several stages. The discharge gas is excited by the collision of electrons against gas molecules and generates vacuum ultraviolet rays. The vacuum ultraviolet rays collide against phosphors in discharge cells and generate visible light that reaches a viewer's eyes through a transparent front substrate. During these stages, considerable input energy applied to the sustain and the scan electrodes is lost.

The glow discharge is generated by applying a voltage higher than a discharge firing voltage between both electrodes. Therefore, in order to fire the glow discharge, a considerably high voltage is required. Once discharge is generated, the voltage distribution between a cathode and an anode is distorted due to a space charge effect caused by dielectric layers in the vicinities of the cathode and the anode electrodes. That is, between the two electrodes, a cathode sheath region, an anode sheath region, and a positive column region are formed. The cathode region is a region in the vicinity of the cathode electrode, in which most of the voltage applied between the two electrodes is consumed. The anode sheath region is a region in the vicinity of the anode electrode, in which some of the voltage is consumed. The positive column region is a region between the cathode sheath region and the anode sheath region, in which almost no voltage is consumed. Electron heating efficiency of the cathode sheath region depends on the secondary electron coefficient of an MgO protective film that is formed on the surface of the dielectric layer. In the positive column region, most of the input energy is consumed for electron heating.

The vacuum ultraviolet rays which discharge visible light by colliding against the phosphors are generated when Xe gas changes from an excitation state to a ground state. The excitation state of Xe gas is generated by the collision between Xe gas and electrons. Therefore, in order to increase the ratio of visible light generated to the input energy (luminescence efficiency), the collisions between Xe gas and electrons must be increased. Further, in order to increase these collisions, the electron heating efficiency must be increased.

While most of the input energy is consumed in the cathode sheath region, the electron heating efficiency in this region is low. In the positive column region, consumption of the input energy is low and the electron heating efficiency is high. Accordingly, high luminescence efficiency can be obtained by increasing the positive column region, which can be achieved by enlarging a discharge gap.

On the other hand, the higher the partial pressure of Xe, the higher the luminescence efficiency.

As the electric field is reduced, the ratio E/n of the electric field E applied to the discharge gap to the gas density n changes, and the ratios of electron consumption for xenon excitation Xe*, xenon ions Xe⁺, neon excitation Ne*, and neon ions Ne⁺ to the overall electrons change. At the same reduced ratio E/n, the higher the partial pressure of Xe, the lower the electron energy. If the electron energy decreases, the ratio of electrons to be consumed for the excitation of Xe increases. Because vacuum ultraviolet rays that generate visual light are generated when the Xe gas changes from the excitation state to the ground state, as the ratio of electrons to be consumed for the excitation of Xe increases, luminescence efficiency is enhanced.

As described above, an increase of the area or length of the positive column region results in an increase in electron heating efficiency. Further, an increase of the partial pressure of Xe results in an increase in electron heating efficiency of electrons to be consumed for the excitation of Xe. Accordingly, both factors result in an increase in electron heating efficiency, thereby enhancing luminescence efficiency.

However, an increase of the positive column region or an increase of the partial pressure of Xe results in increase in the discharge firing voltage, which increases the manufacturing cost of the PDP.

Accordingly, an increase in the area or lenght of the positive column region and an increase of the partial pressure of Xe must be achieved under a low discharge firing voltage, in order to enhance luminescence efficiency. Therefore, there is a need for reducing the discharge firing voltage of a PDP observing that for comparable distance and pressure of the discharge gap, the discharge firing voltage required for the opposing discharge structure is lower than the discharge firing voltage required for the surface discharge structure.

### SUMMARY OF THE INVENTION

The present invention provides a plasma display panel which can reduce a discharge firing voltage as well as reset and address periods, thereby enhancing power of gray-scale representation, and a method of driving a plasma display panel.

The present invention provides a plasma display panel which can induce an opposing discharge, reduce a discharge firing voltage by firing a discharge at a short gap, and increase a main discharge length, thereby enhancing luminescence efficiency.

According to an aspect of the present invention, a plasma display panel includes first and second substrates facing each other with a predetermined gap therebetween. The predetermined gap is divided into a plurality of discharge having phosphor layers formed in the discharge cells. First and second electrodes extend in a first direction between the substrates and are alternately located on boundaries of discharge cells that are adjacent along in a second direction intersecting the first direction. The first and second electrodes also extend from the first substrate toward the second substrate in a direction perpendicular to the first and second directions. First and second address electrodes extend in the second direction between the substrates corresponding to the boundaries of the discharge cells that are adjacent in the first direction, and have protruding portions alternately protruding within their respective discharge cells that are located adjacent to one another along the second direction.

The plasma display panel may further include a first barrier rib layer that is adjacent to the first substrate for defining a plurality of first discharge spaces, and a second barrier rib layer that is adjacent to the second substrate for defining second discharge spaces facing the first discharge spaces. Each discharge cell is defined by a pair of the first and second discharge spaces facing each other.

Each of the second discharge spaces defined by the second barrier rib layer may have a volume larger than that of each of the first discharge spaces defined by the first barrier rib layer.

The first barrier rib layer may include first barrier rib members that are formed in the second direction and second barrier rib members that are formed to intersect the first barrier rib members. Further, the second barrier rib layer may include third barrier rib members that are formed in the second direction and fourth barrier rib members that are formed to intersect the third barrier rib members.

The first electrodes, the second electrodes, the first address electrodes, and the second address electrodes may be located between the first barrier rib layer and the second barrier rib layer.

A dielectric layer may be provided on outer surfaces of the first address electrodes and the second address electrodes.

The first and second address electrodes may be located on the same side with respect to the first and second electrodes in a direction perpendicular to the first and second substrates. In this case, the first address electrodes may be located adjacent to either of the substrates and the second address electrodes may be located adjacent to the first and second electrodes.

On the other hand, a thickness of a dielectric layer formed between each of the protruding portions of the first address electrodes and each of the second electrodes may be formed larger than a thickness of the dielectric layer formed between each of the protruding portions of the second address electrodes and each of the second electrodes. The dielectric thickness may be measured between the protruding portions and an inside of the discharge cell in a direction perpendicular to the substrates. In addition, a protective film may be provided on outer surface of the dielectric layer. The protective film may be made of a material having a non-transmissive property for visible light, thereby further increasing a secondary electron emission coefficient.

The first and second address electrodes may be made of a metal having superior conductivity.

A distance between each of the protruding portions of the first and the second address electrodes and each of the second electrodes may be smaller than a distance between each of the protruding portions and each of the first electrodes. As such, an address discharge can be more easily performed with a low voltage.

The dielectric layer formed on the outer surface of each of the protruding portions of the first and the second address electrodes may be directly connected to the dielectric layer formed on the outer surface of each of the second electrodes. Alternatively, these dielectric layers may merge together or be formed as one continuous layer.

Further, the first and the second address electrodes may each include a plurality of protruding portions located between the first and second electrodes in each one of the discharge cells. A trigger discharge is generated with this structure, which facilitates the generation of the address discharge and the sustain discharge.

The protruding portions of the first address electrodes may be located adjacent to one of the substrates, the protruding portions of the second address electrodes may be located adjacent to the first electrodes and the second electrodes, and the number of the protruding portions located adjacent to the substrates may be different from that of the protruding portions located adjacent to the first electrodes and the second electrodes.

Each of the first address electrodes and the second address electrodes may be provided with two protruding portions.

The two protruding portions of each of the first address electrodes may be respectively provided adjacent to the first and second electrodes of a first discharge cell among adjacent first and second discharge cells that are adjacent in the second direction, and a protruding portion thereof may be provided adjacent to the first electrode of the second discharge cell. Further, one protruding portion of each of the second address electrodes may be provided adjacent to the second electrode of the second discharge cell.

Each of the first and second electrodes may have a vertical length longer than a horizontal length in a cross-sectional view of the first and second electrodes that is perpendicular to the first direction. In one embodiment, the cross-sections of the first and second electrodes are symmetrically formed with respect to the direction perpendicular to the substrates. In one embodiment, the first and second electrodes are made of a metal having superior conductivity. A dielectric layer may be formed on outer surfaces of the first and second electrodes, and a protective film may be formed on an outer surface of the dielectric layer. Additionally, the phosphor layers may include first phosphor layers that are formed in the respective discharge cells on the first substrate side and second phosphor layers that are formed in the respective discharge cells on the second substrate side. The first phosphor layers may be made of reflective phosphors, and the second phosphor layers may be made of transmissive phosphors. In one embodiment, a thickness of each of the first phosphor layers is larger than a thickness of each of the second phosphor layers.

In addition, each of the first electrodes and the second electrodes may have expanding portions that extend in a direction perpendicular to the surface of each substrate.

In addition, the protruding portions of the first address electrodes and the protruding portions of the second address electrodes may alternately protrude toward the insides of their respective discharge cells from opposite sides of the respective discharge cells.

In one embodiment, each of the expanding portions of the first electrodes and each of the second electrodes have a vertical dimension along a third direction perpendicular to the first and second directions that is longer than a horizontal dimension along the second direction in cross-sectional view of the expanding portions of the first and second electrodes.

The first barrier rib layer may have first barrier rib members that extend in the second direction, and the second barrier rib layer may have third barrier rib members that extend in the second direction.

According to another aspect of the present invention, in a plurality of the discharge cells continuously located adjacent to one another along the second direction, the first address electrodes may have protruding portions that protrude between the first and second electrodes provided in one discharge cell, and the second address electrodes may have protruding portions that protrude between the first and second electrodes provided in an adjacent discharge cell.

In addition, the first address electrodes may be located closer to the first substrate and the second address electrodes may be located closer to the second substrate, with the first and second electrodes located between the first and second address electrodes.

The first and second electrodes may have expanding portions that correspond to the respective discharge cells and extend in a direction perpendicular to the substrates, and narrow portions that correspond to boundaries of the discharge cells continuously located adjacent to one another in the first direction and have narrower widths than the expanding portions.

The protruding portions of the first and second address electrodes may protrude toward the insides of their respective discharge cells on the same side of the discharge cell. Further, the protruding portions of the first and second address electrodes may protrude toward the insides of the respective discharge cells on opposite sides of the respective discharge cells.

One sub-pixel is formed by a plurality of discharge cells. For example, four adjacent discharge cells may form one sub-pixel through an electrode arrangement in an order of the first electrode, the second electrode, the first electrode, the second electrode, and the first electrode.

In this case, in the second direction, one of the second electrodes is located between the protruding portions of the first address electrodes, and the other second electrode is located between the protruding portions of the second address electrodes. Further, the first electrodes are located between one protruding portion of the first address electrodes and one protruding portion of the second address electrodes that is adjacent to the one protruding portion of the first address electrodes.

According to still another aspect of the present invention, a plasma display panel includes a first substrate and a second substrate that are located to face each other, barrier ribs that define a plurality of discharge cells in a space between the first substrate and the second substrate, phosphor layers that are formed in the discharge cells, first electrodes and second electrodes that are formed to extend in a first direction between the first substrate and the second substrate and are formed to extend toward the second substrate in a direction away from the first substrate so as to face each other with spaces therebetween, and are shared by a pair of adjacent discharge cells in a second direction intersecting the first direction, and first and second address electrodes that extend in the second direction on the first substrate and are located in parallel with each other corresponding to the respective discharge cells.

Each of the first and second address electrodes may have first portions that protrude inside each discharge cell, and a second portion that connects the first portions.

The first portions of the first address electrodes and the first portions of the second address electrodes may be alternately located in adjacent discharge cells located along the second direction. The first portions of the first address electrodes and the first portions of the second address electrodes may protrude inside the respective discharge cells from opposite sides of discharge cells that are adjacent in the second direction.

The first portions of the first address electrodes and the first portions of the second address electrodes may be symmetrically located with respect to the first electrodes or the second electrodes.

The second electrodes may be sequentially applied with scan pulses in an address period so as to be involved in an address discharge, and the first electrodes may be applied with a sustain voltage, together with the second electrodes, in a sustain period so as to be involved in a sustain discharge.

Among a pair of discharge cells that share the second electrodes and are adjacent in the second direction, in one discharge cell, the first address electrode may have an area smaller than that of the second address electrode, and in the other discharge cell, the first address electrode may have an area larger than that of the second address electrode.

An edge of each of the first and second address electrodes at an edge of the discharge cell may be located substantially in parallel with the edge of the discharge cell.

The edge of each of the first and second address electrodes at the edge of the discharge cell may be formed inclined further toward the center of the discharge cell in the first portions than in the second portions.

In another embodiment, at least one of the first electrodes and the second electrodes protrudes further inside the discharge cell in a region close to the first substrate than in a region close to the second substrate.

The width of at least one of the first electrodes and the second electrodes along the second direction becomes larger in steps or gradually from a region closer to the second substrate toward a region closer to the first substrate.

A dielectric layer may be formed on the outer surfaces of the first electrodes and the second electrodes, and the dielectric layer may have a first dielectric layer portion that is formed in parallel with the first and second electrodes so as to surround the respective first and second electrodes and a second dielectric layer portion that is formed in a direction intersecting the first dielectric layer portion along the edge of the discharge cell.

According to a further aspect of the present invention, there is provided a method of driving a plasma display panel which has first electrodes and second electrodes formed to extend in a first direction between a first and a second substrate facing each other, shared by adjacent discharge cells that are adjacent in a second direction intersecting the first direction and are alternately arranged. The panel also includes first and second address electrodes formed to extend in the second direction and located to be spaced from each other in a direction perpendicular to the substrates. The method of driving a plasma display panel includes, in an address period, applying a scan pulse to a second electrode which is shared by adjacent first and second discharge cells in the second direction, and addressing the first and second discharge cells to which the scan pulse is applied.

In the addressing, the first discharge cell may be addressed by the first address electrode and the second discharge cell may be addressed by the second address electrodes.

Further, addressing by the first and second address electrodes can be simultaneously performed.

An address pulse may be applied to the first address electrodes from a first address electrode driver, and an address pulse may be applied to the second address electrodes from a second address electrode driver.

In one embodiment, a value of the address pulse applied to either the first address electrode or the second address electrode located close to the second electrode is equal to or less than a value of the address pulse applied to the other address electrode.

In one embodiment, the value of the address pulse applied to the second address electrode is equal to or less than the value of the address pulse applied to the first address electrode.

In the addressing, the first discharge cell may be addressed by the first address electrode, and the second discharge cell may be addressed by the second address electrode, such that addressing by the first and second address electrodes can be sequentially performed. In the addressing, one of the first and second discharge cells, in which the distance between the second electrode and the address electrode is larger, is first addressed, and then the other discharge cell is addressed.

That is, in the addressing, the first discharge cell in which the first address electrode is provided is first addressed, and then the second discharge cell in which the second address electrode is provided is addressed.

In this case, an address pulse is applied to the first address electrode from an address electrode driver, and then the address pulse is applied to the second address electrode from the address electrode driver.

### BRIEF DESCRIPTION OF THE DRAWINGS

FIG. 1 is a partial exploded perspective view of a plasma display panel according to a first embodiment of the present invention.

FIG. 2 is a partial plan view schematically showing structures of electrodes and discharge cells in the plasma display panel according to the first embodiment of the present invention.

FIG. 3 is a partial cross-sectional view taken along the line III-III of FIG. 1 in a state in which the plasma display panel is assembled.

FIG. 4 is a partial perspective view schematically showing structures of the electrodes in the plasma display panel according to the first embodiment of the present invention.

FIG. 5 is a schematic view showing a first connection relationship of first and second address electrodes and respective drivers in the plasma display panel according to the first embodiment of the present invention.

FIG. 6 is a diagram showing driving waveforms in a first driving method of the plasma display panel according to the first embodiment of the present invention.

FIG. 7 is a schematic view showing a second connection relationship of the first and second address electrodes and the respective drivers in the plasma display panel according to the first embodiment of the present invention.

FIG. 8 is a diagram showing driving waveforms in a second driving method of the plasma display panel according to the first embodiment of the present invention.

FIG. 9 is a partial cross-sectional view of a plasma display panel according to a second embodiment of the present invention.

FIG. 10 is a partial cross-sectional view of a plasma display panel according to a third embodiment of the present invention.

FIG. 11 is a partial cross-sectional view of a plasma display panel according to a fourth embodiment of the present invention.

FIG. 12 is a partial cross-sectional view of a plasma display panel according to a fifth embodiment of the present invention.

FIG. 13 is a partial perspective view schematically showing structures of the electrodes in a plasma display panel according to a sixth embodiment of the present invention.

FIG. 14 is a partial plan view of a plasma display panel according to a seventh embodiment of the present invention.

FIG. 15 is a partial plan view of a plasma display panel according to an eighth embodiment of the present invention.

FIG. 16 is a partial cross-sectional view of a plasma display panel according to a ninth embodiment of the present invention.

FIG. 17 is a partial exploded perspective view of a plasma display panel according to a tenth embodiment of the present invention.

FIG. 18 is a partial plan view schematically showing structures of the electrodes and the discharge cells in the plasma display panel according to the tenth embodiment of the present invention.

FIG. 19 is a partial cross-sectional view taken along the line XIX-XIX of FIG. 17 in a state in which the plasma display panel is assembled.

FIG. 20 is a partial perspective view schematically showing structures of the electrodes in the plasma display panel according to the tenth embodiment of the present invention.

FIG. 21 is a partial plan view schematically showing structures of the electrodes and the discharge cells in a plasma display panel according to an eleventh embodiment of the present invention.

FIG. 22 is a partial cross-sectional view of a plasma display panel according to a twelfth embodiment of the present invention.

FIG. 23 is a partial exploded perspective view of a plasma display panel according to a thirteenth embodiment of the present invention.

FIG. 24 is a partial cross-sectional view taken along the line IIXIV-IIXIV of FIG. 23 in a state in which the plasma display panel is assembled.

FIG. 25 is a partial plan view schematically showing the plasma display panel according to the thirteenth embodiment of the present invention.

FIG. 26 is a partial cross-sectional view of a plasma display panel according to a fourteenth embodiment of the present invention.

FIG. 27 is a partial cross-sectional view of a plasma display panel according to a fifteenth embodiment of the present invention.

FIG. 28 is a partial plan view of a plasma display panel according to a sixteenth embodiment of the present invention.

### DETAILED DESCRIPTION

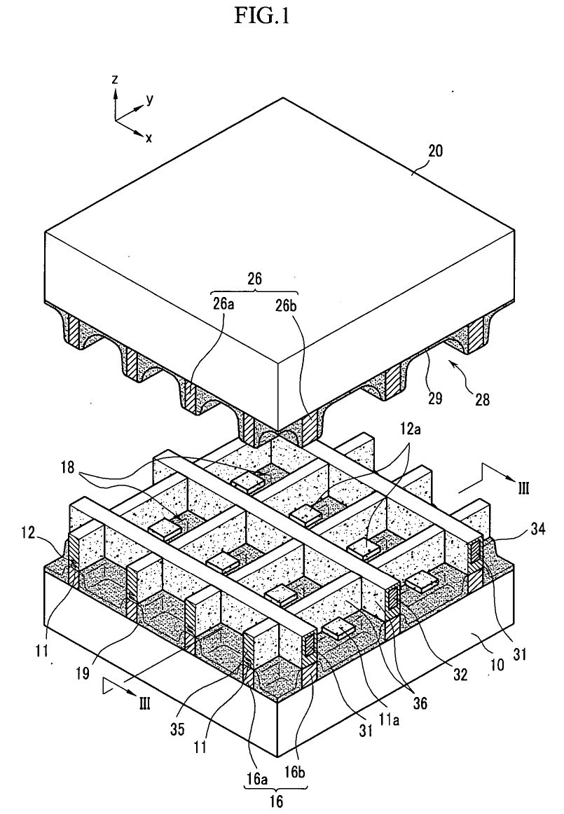

Referring to FIGS. 1 to 4, the PDP according to the first embodiment of the present invention includes a first substrate 10 (hereinafter, referred to as ‘rear substrate’) and a second substrate 20 (hereinafter, referred to as ‘front substrate’) that face each other with a predetermined gap therebetween, and a first barrier rib layer 16 (hereinafter, referred to as ‘rear-substrate-side barrier rib’) and a second barrier rib layer 26 (hereinafter, referred to as ‘front-substrate-side barrier rib’) that are located between the rear substrate 10 and the front substrate 20. The rear-substrate-side barrier rib 16 and the front-substrate-side barrier rib 26 define a plurality of discharge spaces so as to form first discharge spaces 18 and second discharge spaces 28 facing each other. In the discharge spaces 18 and 28, phosphor layers 19 and 29 are formed so as to absorb vacuum ultraviolet rays and to emit visible light. Further, a discharge gas (for example, a mixed gas including Xe, Ne, and the like) is filled into discharge cells 17 so as to generate the vacuum ultraviolet rays by a plasma discharge.

The rear-substrate-side barrier rib 16 is formed to protrude toward the front substrate 20 from the rear substrate 10, and the front-substrate-side barrier rib 26 is formed to protrude toward the rear substrate 10 from the front substrate 20. The rear-substrate-side barrier rib 16 defines a plurality of discharge spaces near the rear substrate 10 so as to form the first discharge spaces 18 on the rear substrate 10. The front-substrate-side barrier ribs 26 define a plurality of discharge spaces near the front substrate 20 so as to form the second discharge spaces 28 on the front substrate 20. The discharge spaces facing each other on both sides substantially form one discharge cell 17. In the present invention, as long as a specified indication on the discharge cell 17 is not given, the discharge cell 17 means one discharge space that is formed by first and second discharge spaces 18, 28.

In one embodiment, the discharge spaces formed by the front-substrate-side barrier ribs 26 and the second discharge spaces 28, have volumes larger than those of the discharge spaces formed by the rear-substrate-side barrier ribs 16 and the fist discharge spaces 18. With the difference in volume, transmittance of visible light generated in the discharge cell 17 passing through the front substrate 20 can be enhanced.

The rear-substrate-side barrier rib 16 and the front-substrate-side barrier rib 26 can form the discharge cells 17 to have various shapes, such as rectangular or hexagonal. In the present embodiment, the discharge cells 17 having rectangular shapes are given as an example.

The rear-substrate-side barrier rib 16 includes first barrier rib members 16a and second barrier rib members 16b. The first barrier rib members 16a are located on an inner surface of the rear substrate 20 to extend in one direction (a y-axis direction), and the second barrier rib members 16b are located to extend in a direction intersecting the first barrier rib members 16a. Accordingly, the first barrier rib members 16a and the second barrier rib members 16b form the first discharge spaces 18 as independent discharge spaces.

The front-substrate-side barrier ribs 26 include third barrier rib members 26a and fourth barrier rib members 26b. The third barrier rib members 26a are formed on an inner surface of the front substrate 20 to protrude toward the rear substrate 10 and have shapes corresponding to the first barrier rib members 16a. The fourth barrier rib members 26b are formed to extend in a direction intersecting the third barrier rib members 26a and to have shapes corresponding to the second barrier rib members 16b. Accordingly, the third barrier rib members 26a and the fourth barrier rib members 26b form the second discharge spaces 28 on the front substrate 20. The second discharge spaces 28 correspond to the first discharge spaces 18 formed on the rear substrate 10 by the first barrier rib members 16a and the second barrier rib members 16b.

The phosphor layers 19 and 29 are formed in the discharge spaces as described above. The phosphor layers 19 and 29 include first phosphor layers 19 that are formed in the first discharge spaces 18 on the rear substrate 10 and second phosphor layers 29 that are formed in the second discharge spaces 28 on the front substrate 20 facing the first discharge spaces 18.

The first discharge spaces 18, formed by the rear-substrate-side barrier ribs 16, and the second discharge spaces 28, formed by the front-substrate-side barrier ribs 26 to face the first discharge spaces 18, substantially correspond to one discharge cell 17. Therefore, the first phosphor layers 19 and the second phosphor layers 29 formed in the respective discharge spaces generate visible light of the same color due to vacuum ultraviolet rays caused by a gas discharge. The first phosphor layers 19 and the second phosphor layers 29 generate visible light from both of the discharge spaces 18 and 28, which substantially form one discharge cell 17, such that luminescence efficiency can be enhanced.

The first phosphor layers 19 are formed on the inner surfaces of the first barrier rib members 16a and the second barrier rib members 16b and the surface of the rear substrate 10 in the first discharge spaces 18. The second phosphor layers 29 are formed on the inner surfaces of the third barrier rib members 26a and the fourth barrier rib members 26b and the surface of the front substrate 20 within the second discharge spaces 28.

On the other hand, as shown FIGS. 1 through 4, the first phosphor layers 19 can be formed by forming the rear-substrate-side barrier rib 16 on the rear substrate 10 and by coating phosphors on the rear-substrate-side barrier rib 16. Alternatively, the first phosphor layers 19 may be formed by etching the rear substrate 10 to correspond to the shapes of the first discharge spaces 18 and by coating phosphors on the etched surfaces. Similarly, as shown in the drawings, the second phosphor layers 29 can be formed by forming the front-substrate-side barrier ribs 26 on the front substrate 20 and by coating phosphors on the front-substrate-side barrier ribs 26. Alternatively, the second phosphor layers 29 may be formed by etching the front substrate 20 to correspond to the shapes of the second discharge spaces 28 and by coating phosphors on the etched surfaces.

In the case in which the rear-substrate-side barrier rib 16 is formed by etching the rear substrate 10, the rear substrate 10 and the rear-substrate-side barrier rib 16 are made of the same material (not shown). In the case in which the front-substrate-side barrier rib 26 is formed by etching the front substrate 20, the front substrate 20 and the front-substrate-side barrier rib 26 are made of the same material (not shown). By use of such an etching method, manufacturing costs can be reduced, as compared with a method in which the rear-substrate-side barrier rib 16 and the front-substrate-side barrier rib 26 are formed separately from the rear substrate 10 and the front substrate 20.

The first phosphor layers 19 absorb the vacuum ultraviolet rays in the first discharge spaces 18 on the rear substrate 10 and the second phosphor layers 29 absorb the vacuum ultraviolet rays in the second discharge spaces 28 on the front substrate 20, and generate visible light. Further, the first phosphor layers 19 are made of reflective phosphors that reflect visible light, and the second phosphor layers 29 are made of transmissive phosphors that transmit visible light. As a result, the generated light travels toward the front substrate 20. Therefore, in order to enhance luminescence efficiency of visible light passing through the front substrate 20, in one embodiment, a thickness t₁ of each of the first phosphor layers 19 formed on the rear substrate 10 is larger than a thickness t₂ of each of the second phosphor layers 29 formed on the front substrate 20 (t₁>t₂). In addition, the particle size of a phosphor powder forming the first phosphor layers 19 may be larger than the particle size of a phosphor powder forming the second phosphor layers 29. In such a manner, because the thickness t₂ of each of the second phosphor layers 29 is smaller than the thickness t₁ of each of the first phosphor layers 19, loss of vacuum ultraviolet rays passing through the front substrate 20 can be minimized and thus luminescence efficiency can be enhanced.

In order to realize images by plasma discharge, the plasma display panel of the present invention has first address electrodes 11 and second address electrodes 12, and first electrodes 31 (hereinafter, referred to as ‘sustain electrodes’), and second electrodes 32 (hereinafter, referred to as ‘scan electrodes) between the rear substrate 10 and the front substrate 20 corresponding to the respective discharge cells 17.

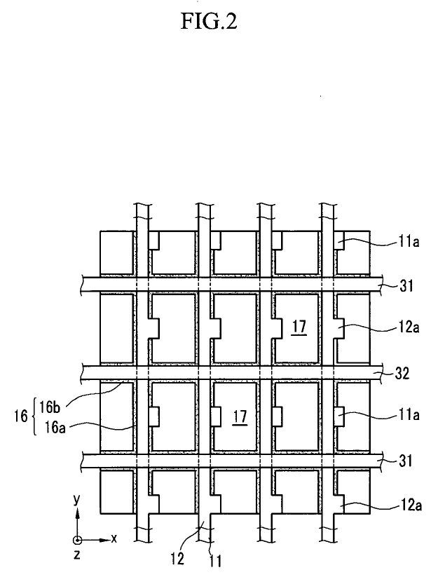

As shown in FIG. 2, the sustain electrodes 31 and the scan electrodes 32 are formed between the rear-substrate-side barrier ribs 16 and the front-substrate-side barrier ribs 26 to extend in a first direction (hereinafter, referred to as ‘x-axis direction’). In addition, the first address electrodes 11 and the second address electrodes 12 are alternately located along the boundaries of the discharge cells 17 in a second direction (hereinafter, referred to as ‘y-axis direction’) intersecting the x-axis direction, and form an opposing discharge structure with respect to the sustain and scan electrodes 31 and 32. Each of the sustain electrodes 31 is located between two groups of discharge cells 17 on both sides of the sustain electrode 31. Similarly, each of the scan electrodes 32 is located between two groups of adjacent discharge cells 17. For this reason, each of the sustain and scan electrodes 31 and 32 is involved in the sustain discharge if its two groups of adjacent discharge cells 17 on both sides.

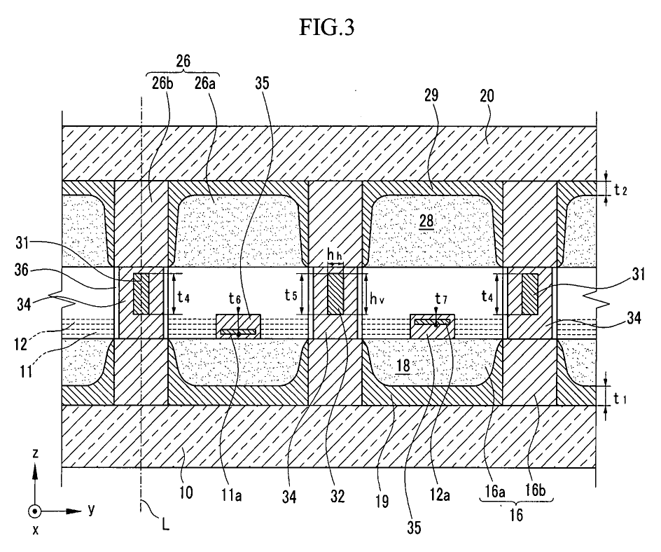

As FIGS. 1 and 3 show, the distance between the first and second address electrodes 11 and 12 and the rear-substrate-side barrier rib 16 is set shorter than the distance between the sustain and scan electrodes 31 and 32 and the rear-substrate-side barrier rib 16. Alternatively, The distance between the first and second address electrodes 11 and 12 and the front-substrate-side barrier rib 26 may be set shorter than the distance between the sustain and scan electrodes 31 and 32 and the front-substrate-side barrier rib 26. The first address electrodes 11 and the second address electrodes 12 are located along a direction parallel to the substrates while spaced away from each other along a direction perpendicular to the substrates. In addition, the first address electrodes 11 and the second address electrodes 12 are aligned along the direction parallel to the substrates located in order to overlap each other. Cross-sectional views of the first and second address electrodes 1 and 12 viewed perpendicular to the first and second substrate 10 and 20 show the alignment of the first and second address electrodes 11 and 12. Specifically, the first address electrodes 11 are provided adjacent to either the rear-substrate-side barrier ribs 16 or the front-substrate-side barrier ribs 26. The second address electrodes 12 are provided adjacent to the sustain electrodes 31 and the scan electrodes 32. In other words, whether the first and second address electrodes 11 and 12 are formed closer to the front substrate 20 or closer to the back substrate 10, they are closer to the substrate than the sustain and scan electrodes 31 and 32 of the corresponding embodiment.

Because the first and second address electrodes 11 and 12 are located to overlap each other along the direction parallel to the substrates, the first address electrodes 11 and the second address electrodes 12 may alternately address adjacent discharge cells 17 in the y-axis direction. In order to alternately address adjacent discharge cells 17 in the y-axis direction, the first address electrodes 11 and the second address electrodes 12 are provided with protruding portions 11a and 12a, respectively. The protruding portions 11a and 12a are not overlapping. The protruding portions 11a of the first address electrodes 11 are provided adjacent to either the rear-substrate-side barrier ribs 16 or the front-substrate-side barrier ribs 26, and the protruding portions 12a of the second address electrodes 12 are provided adjacent to the sustain electrodes 31 and the scan electrodes 32.

FIG. 3 exemplifies the configuration in which the first address electrodes 11 and the second address electrodes 12 are located closer to the rear-substrate-side barrier rib 16. The first address electrodes 11 and the second address electrodes 12 are located in a direction intersecting the sustain electrodes 21 and the scan electrodes 32. The first address electrodes 11 and the second address electrodes 12 respectively have protruding portions 11a and 12a that alternately correspond to the discharge cells 17 located in the y-axis direction, thereby alternately being involved in addressing of adjacent discharge cells 17 in the y-axis direction.

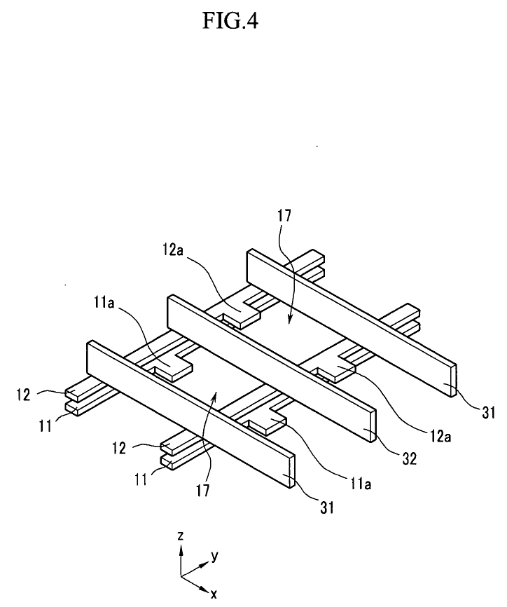

As shown in FIGS. 2 and 4, as viewed by one of the discharge cells 17, the first address electrodes 11 and the second address electrodes 12 are located to overlap each other on the same side (between the sustain and scan electrodes 31 and 32 and the rear-substrate side barrier rib 16). However, the first address electrodes 11 and their protruding portions 11a address one of discharge cells 17 among a pair of discharge cells 17 adjacent in the y-axis direction, and the second address electrodes 12 and their protruding portions 12a address the other discharge cell 17 among a pair of discharge cells 17 adjacent in the y-axis direction. The first address electrodes 11 and the second address electrodes 12 alternately address the adjacent discharge cells 17 that are located along the y-axis direction.

The first address electrodes 11 and the second address electrodes 12 correspond to the first barrier rib members 16a and the third barrier rib members 26a. The first address electrodes 11 and the second address electrodes 12 are formed between the first barrier rib members 16a and the third barrier rib members 26a to extend in a direction parallel therewith (y-axis direction). The first address electrodes 11 and the second address electrodes 12 are formed to overlap each other. In addition, the overlapping sets of first and second address electrodes 11 and 12 are located in parallel separated by intervals corresponding to the size of the discharge cells 17 in the x-axis direction. The first address electrodes 11 and the protruding portions 11a thereof are provided adjacent to the rear-substrate-side barrier ribs 16, and the second address electrodes 12 and the protruding portions 12a thereof are provided adjacent to the sustain electrodes 31 and the scan electrodes 32. The first address electrodes 11 and the second address electrodes 12 are provided closer to the rear-substrate-side barrier rib 16 than to the sustain electrodes 31 and the scan electrodes 32. For this reason, the sustain electrodes 31 and the scan electrodes 32 do not interfere with the first address electrodes 11 and the second address electrodes 12 that are located in a direction intersecting the direction of the sustain electrodes 31 and the scan electrodes 32.

In an exemplary arrangement, the protruding portions 11a of the first address electrodes 11 are formed to correspond to a group of adjacent discharge cells 17 located along the y-axis direction and corresponding to the even-numbered rows, and the protruding portions 12a of the second address electrodes 12 are formed to correspond to a group of adjacent discharge cells 17 located along the y-axis direction and corresponding to the odd-numbered rows. Alternatively, the protruding portions 11a and 12a may be located to correspond to the rows of odd-numbered discharge cells 17 and the even-numbered discharge cells 17, respectively. The first address electrode 11 and the second address electrode 12 perform addressing through interaction with the scan electrode 32, and thus the protruding portion 11 a of the first address electrode 11 protrudes toward the center of one of a pair of adjacent discharge cells 17 sharing the scan electrode 32, and the protruding portion 12a of the second address electrode 12 protrudes toward the center of the other discharge cell 17 sharing the same scan electrode 32. The protruding portions 11a of the first address electrodes 11 and the protruding portions 12a of the second address electrodes 12 are alternately located in the adjacent discharge cells 17 located along the y-axis direction.

The first address electrodes 11 and the second address electrodes 12 are provided between the first barrier rib members 16a and the third barrier rib members 26a serving as a non-discharging region. Therefore, because visible light generated in the discharge cells 17 is not shielded by the first and second electrodes 11 and 12, these electrodes can be made of non-transparent materials or a metal having superior conductivity. Each of the protruding portions 11a and 12a protrudes toward the center of the discharge cell 17, and thus the protruding portions 11a and 12a may be made of transparent electrodes. Alternatively, the protruding portions 11a and 12a can be made of the same material as those of the first address electrodes 11 and the second address electrodes 12.

The address pulse is applied to each of the first address electrodes 11 and the second address electrodes 12. The protruding portions 11a of the first address electrodes 11 and the protruding portions 12a of the second address electrodes 12 serve to apply the address pulses to the discharge cells 17. That is, if the scan pulse is applied to the scan electrode 32 and the address pulses are applied to the first address electrode 11 and the second address electrode 12, double addressing can be realized by one scan operation. Further, the discharge gap between the protruding portions 11a and 12a and the scan electrode 32 in each discharge cell 17 are formed as a short gap, thereby enabling the address discharge with a low voltage.

On the other hand, the sustain electrode 31 and the scan electrode 32 are formed between the rear-substrate-side barrier ribs 16 and the front-substrate-side barrier ribs 26 with respect to the z-axis direction of the rear substrate 10 and the front substrate 20, as shown in FIGS. 1 and 3. The sustain electrode 31 and the scan electrode 32 are electrically isolated from the first address electrode 11 and the second address electrode 12 and formed to extend along the direction (x-axis direction) intersecting the direction of the first and second address electrodes 11 and 12. For each row of adjacent discharge cells 17, one of the sustain electrodes 31 is located on one side, and one of the scan electrodes 32 is located on the other side in parallel with the sustain electrode 31. Consequently, the sustain electrodes 31 and the scan electrodes 32 are alternately located along the x-axis direction and are distanced apart from one another along the y-axis direction so as to be shared by adjacent discharge cells 17 located along a row of discharge cells in the x-direction. The scan electrodes 32 are provided between the second barrier rib member 16b and the fourth barrier rib member 26b, which divide two adjacent discharge cells 17, and the sustain electrodes 31 are also provided between the second barrier rib member 16b and the fourth barrier rib member 26b, which divide the two adjacent discharge cells 17. Therefore, when the address pulse is applied to the first address electrode 11 and the second address electrode 12, and the scan pulse is applied to the scan electrode 32, the two adjacent discharge cells 17 sharing the same scan electrode 32 and the same first and second address electrodes 11 and 12 can be selected by one scan operation. That is, double addressing can be realized by one scan operation, thereby reducing the duration of the address period. Further, if the reset pulse is applied to the scan electrode 32, two adjacent discharge cells 17 sharing the same scan electrode 32 are reset, thereby reducing the duration of the reset period. As such, because the reset period and the address period are reduced, the sustain period can be increased. With the increase of the sustain period, the number of sustain pulses is increased, thereby enhancing a power of gray-scale representation.

As shown in FIG. 4, the sustain electrode 31 and the scan electrode 32 are formed and located such that, for adjacent discharge cells 17 in the y-axis direction, double addressing can be realized by one scan operation. In one of a pair of the discharge cells 17 which share the scan electrode 32, the protruding portion 11a of the first address electrode 11 is provided, and in the other discharge cell 17 that shares the scan electrode 32, the protruding portion 12a of the second address electrode 12 is provided. The protruding portions 11a and 12a trigger the discharge between the sustain electrode 31 and the scan electrode 32, which enables the sustain discharge with the low voltage.

The sustain electrodes 31 and the scan electrodes 32 are located between the second barrier rib members 16b and the fourth barrier rib members 26b, thereby serving as the reference to divide adjacent discharge cells 17 in the y-axis direction.

The scan electrodes 32 are involved in addressing in the address period, together with the first address electrodes 11 and the second address electrodes 12, and serve to select the discharge cells 17 to be turned on. The sustain electrodes 31 and the scan electrodes 32 are involved in the sustain discharge in the sustain period, and serve to display the screen. The sustain electrodes 31 are applied with the sustain pulses in the sustain period, and the scan electrodes 32 are applied with the sustain pulses in the sustain period and with the scan pulses in the address period. However, the respective electrodes can perform different functions in accordance with the signal voltages applied thereto, and thus the present embodiment does not need to be limited to the above-described configuration.

Returning to FIG. 3, the sustain electrodes 31 and the scan electrodes 32 are provided between the rear and front substrates 10 and 20 to divide substantially one discharge cell 17, together with the first address electrodes 11 and the second address electrodes 12, such that the opposing discharge structure is formed. Therefore, the discharge firing voltage for the sustain discharge can be reduced.

In order to induce the opposing discharge over a wider area of an opposing surface, the sustain electrodes 31 and the scan electrodes 32 may have cross-sectional structures, in which a vertical length hᵥ is longer than a horizontal length hₕ. The opposing discharge generated over the wide area in such a manner generates strong vacuum ultraviolet rays. The strong vacuum ultraviolet rays collide against the first and second phosphor layers 19 and 29 over a wider area, such that the resultant amount of visible light generated in the discharge cells can be increased.

Further, the sustain electrodes 31 and the scan electrodes 32 are provided between the second barrier rib members 16b and the fourth barrier rib members 26b serving as the non-discharging region so as not to shield visible light generated in the discharge cells 17. Therefore, the sustain electrodes 31 and the scan electrodes 32 may be made of non-transparent materials or may be made of a metal having superior conductivity.

The y-z cross sections of the sustain electrodes 31 and the scan electrodes 32 form symmetric structures with respect to center lines L, shown in FIG. 3, which are perpendicular to the planes of the front substrate 20 and the rear substrate 10. For this reason, the sustain electrode 31 and the scan electrode 32 form the opposing discharge structure with the discharge cell 17 located in between the two electrodes.

Dielectric layers 34 and 35 are provided on outer surfaces of the sustain electrode 31, the scan electrode 32, the first address electrode 11, and the second address electrode 12. The dielectric layers 34 and 35 accumulate wall charges and also insulate the respective electrodes. The dielectric layers 34 and 35 insulating the sustain electrodes 31, the scan electrodes 32, and the first address electrodes 11, and the second address electrodes 12 can be formed by a TFCS (Thick Film Ceramic Sheet) method. The PDP can be manufactured by separately forming an electrode portion including the sustain electrodes 31, the scan electrodes 32, the first address electrodes 11, and the second address electrodes 12, and then by coupling the electrode portion to the rear substrate 10 on which the rear-substrate-side barrier rib 16 is formed.

The dielectric layers 34 and 35 will be described in more detail. In the dielectric layer 35 which covers the first address electrodes 11 and the second address electrodes 12, the thickness t₆ of the dielectric layer 35 along a direction perpendicular to the rear substrate 10 measured between the protruding portions 1la of the first address electrodes 11 and the scan electrodes 32 is set larger than the thickness t₇ of the dielectric layer 35 along the direction perpendicular to the rear substrate 10 measured between the protruding portions 12a of the second address electrodes 12 and the scan electrodes 32. These thicknesses t₆ and t₇ determine the effective electric capacity between the protruding portions 11a and 12a and the scan electrodes 32. The thickness difference of the dielectric layer 35 generates a difference in the discharge firing voltage. The greater the thickness of the dielectric layer 35, the higher the discharge firing voltage, because the discharge is hindered by the dielectric layer. In order to generate the same address discharge, a higher voltage has to be applied to the first address electrode 11 having the dielectric layer 35 thicker than that of the second address electrode 12.

In one embodiment, a protective film 36 is provided on the outer surfaces of the dielectric layers 34 and 35. In particular, the protective film 36 can be formed in portions exposed to the plasma discharge generated in the discharge spaces in the discharge cells 17. The protective film 36 serves to protect the dielectric layers 34 and 35. The protective film 36 needs to have a high secondary electron emission coefficient, but does not need to have a transmissive property for visible light. The sustain electrodes 31, the scan electrodes 32, the first address electrodes 11, and the second address electrodes 12 are provided between the two substrates 10 and 20, not on the front substrate 20 and the rear substrate 10. Therefore, the protective film 36, which is coated on the dielectric layers 34 and 35 while covering the sustain electrodes 31, the scan electrodes 32, the first address electrodes 11, and the second address electrodes 12, can be made of a material having a non-transmissive property for visible light. As an example of the protective film 36, an MgO having a non-transmissive property for visible light has a secondary electron emission coefficient much higher than that of an MgO having a transmissive property for visible light, such that the discharge firing voltage can be further reduced.

The first address electrodes 11 and the second address electrodes 12 are covered by the dielectric layer 35 having the same dielectric constant throughout, and thus the discharge cells showing the red (R), green (G), and blue (B) colors can have the same discharge firing voltage, thereby forming a high voltage margin.

On the other hand, as described above, the sustain electrodes 31 are provided between the second barrier rib members 16b and the fourth barrier rib members 26b, which form one side of a row of the discharge cells 17 in the x-axis direction, and are shared by the discharge cells 17 corresponding to the second and fourth barrier rib members 16b and 26b along that row. The scan electrodes 32 are provided between the second barrier rib members 16b and the fourth barrier rib members 26b, which form another side of the same row of discharge cells 17, and are shared by the discharge cells 17 corresponding to the second and fourth barrier rib members 16b and 26b. Therefore, the sustain electrodes 31 and the scan electrodes 32 are located according to the electrode arrangement in an order of the sustain electrode 31, the scan electrode 32, and the sustain electrode 31.

Further, the first address electrodes 11 and the second address electrodes 12 are provided between the first barrier rib members 16a and the third barrier ribs 26a, which form one side of the discharge cells 17 in the y-axis direction, corresponding to the first and third barrier rib members 16a and 26a. The protruding portions 11a and 12a of the first address electrodes 11 and the second address electrodes 12 are correspondingly located at the centers of the discharge cells 17. Therefore, the electrode arrangement of the sustain electrode 31, the scan electrode 32, and the sustain electrode 31 is substantially made in an order of the sustain electrode 31, the protruding portion 11a of the first address electrode 11, the scan electrode 32, the protruding portion 12a of the second address electrode 12, and the sustain electrode 31 along the y-axis direction.

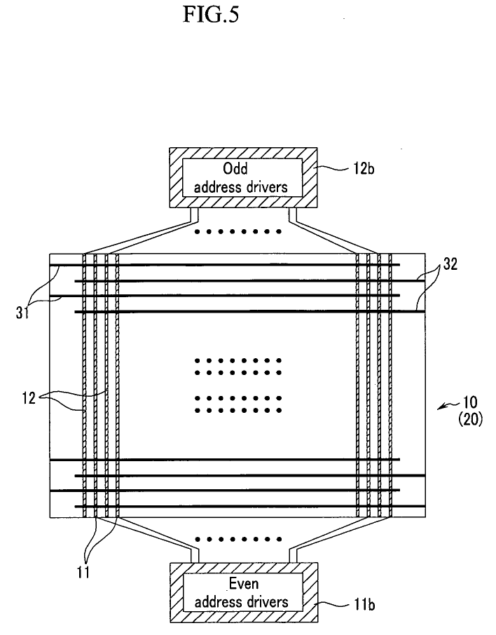

As shown in FIG. 5, the first address electrodes 11 are coupled to a first address electrode driver 11b on one side of the front substrate 10 and the rear substrate 20. The second address electrodes 12 are coupled to a second address electrode driver 12b on the other side of the substrates 10 and 20. This enables a pair of discharge cells 17 sharing the scan electrode 32 to be simultaneously addressed by one scan operation.

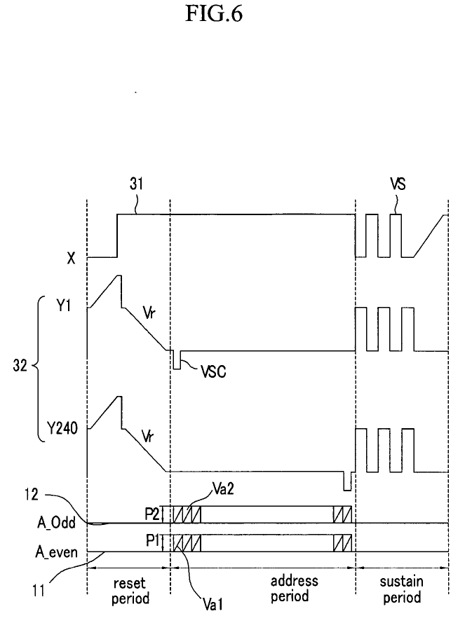

A method of driving a PDP having the above-described configuration is shown in FIG. 6. The method of driving a PDP includes, in the address period, applying a scan pulse V_{sc} to a scan electrode 32, which is shared by a pair of adjacent discharge cells 17, and addressing the pair of the discharge cells 17, to which the scan pulse V_{sc} is applied.

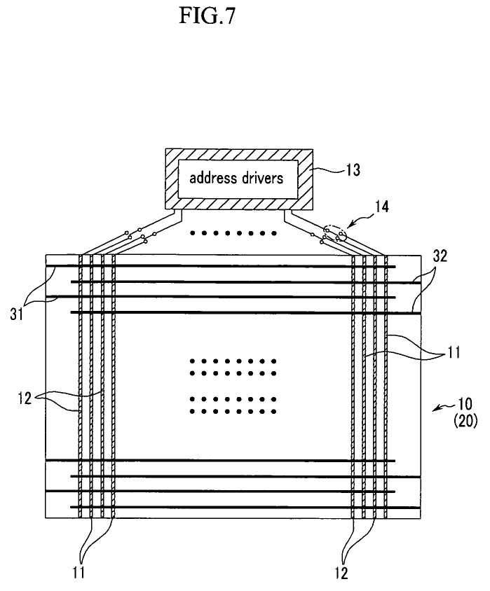

In the addressing, one of the two adjacent discharge cells 17 is addressed by an address pulse Vₐ₁ applied to the first address electrode 11, and the other discharge cell 17 is addressed by an address pulse Vₐ₂ applied to the second address electrode 12. The address pulse Vₐ₁ is applied to the first address electrodes 11 from the first address electrode driver 11b, and the address pulse Vₐ₂ is applied to the second address electrodes 12 from the second address electrode driver 12b (see FIG. 7). Addressing by the first and second address electrodes 11 and 12 is simultaneously implemented

In a resetting stage before the above-described scanning stage and addressing stage, a pair of adjacent discharge cells 17 are simultaneously reset. That is, a reset pulse Vᵣ is applied to one scan electrode 32, such that two adjacent discharge cells 17 are simultaneously reset through the interaction of the scan electrode 32 and the sustain electrodes 31 provided on the two sides of the scan electrode 32. As the reset pulse Vᵣ to be applied in a reset period, a pulse having a known waveform can be used. Further, as the sustain pulse Vₛ to be applied in a sustain period, a pulse having a known waveform can be used.

In one embodiment, a value P₂ of the address pulse applied to either the first address electrode 11 or the second address electrode 12 located close to the scan electrode 32 is equal to or less than a value P₁ of the address pulse applied to the other address electrode 11 or 12. That is, in the present embodiment, the scan electrodes 32 are provided closer to the second address electrodes 12 than to the first address electrodes 11, and thus the value P₂ of the address pulse applied to each of the second address electrodes 12 may be equal to or less than the value P₁ of the address pulse applied to each of the first address electrodes 11. FIG. 6 shows the case in which the pulse values are the same (P₂=P₁).

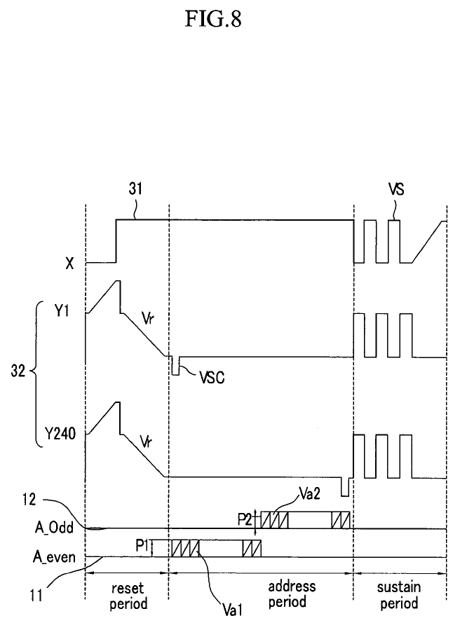

FIG. 7 is a schematic view showing a second connection relationship of the first and second address electrodes and the respective drivers in the plasma display panel according to the first embodiment of the present invention. FIG. 8 is a diagram showing driving waveforms in a second driving method of the plasma display panel according to the first embodiment of the present invention.

Referring to these drawings, in the above-described addressing stage, one of the pair of discharge cells 17 adjacent to each other is addressed by the address pulse Vₐ₁ applied to the first address electrode 11, and the other discharge cell 11 is addressed by the address pulse Vₐ₂ applied to the second address electrode 12. At this time, the address pulse Vₐ₁ is applied to the first address electrode 11 from an address electrode driver 13, and the address pulse Vₐ₂ is applied to the second address electrodes 12 from the address electrode driver 13. In such a manner, only one address electrode driver 13 is provided. Therefore, to selectively apply the address pulse Vₐ₁ and Vₐ₂ to the first address electrode 11 and the second address electrode 12, a switch 14 is provided between the address electrode driver 13 and the first and second address electrodes 11 and 12. With the switch 14, the address electrode driver 13 can be selectively connected to the first address electrodes 11 or the second address electrodes 12.

Addressing is sequentially implemented by the first address electrode 11 and the second address electrode 12. The first address electrode 11 performs addressing first, and then the second address electrode 12 performs addressing. Alternatively, the second address electrode 12 performs addressing first, and then the first address electrode 11 performs addressing. In the addressing stage according to the present embodiment, one of the pair of adjacent discharge cells, of which the distance between the scan electrode 32 and the address electrode is large, is first addressed, and then the other discharge cell is addressed. In the present embodiment, the first address electrode 11 is located distant from the scan electrode 32, as compared with the second address electrode 12, and thus one discharge cell 17 of a pair of adjacent discharge cells, in which the first address electrode 11 is provided, is first addressed, and then the other discharge cell 17, in which the second address electrode 12 is provided, is addressed. More specifically, as the scan period progresses, priming particles vanish. Further, it is hard to perform addressing as the thickness of the dielectric layer becomes larger. Therefore, addressing is first performed by the address electrode in which the dielectric layer 35 is formed larger in thickness, and then addressing is performed by the address electrode in which the dielectric 35 is formed smaller in thickness.

Hereinafter, various embodiments of the present invention will be described. The embodiments to be described below have some parts that are similar to the configuration of the above-described embodiment. Here, the detailed descriptions of the similar parts will be omitted, and only parts that are different will be described.

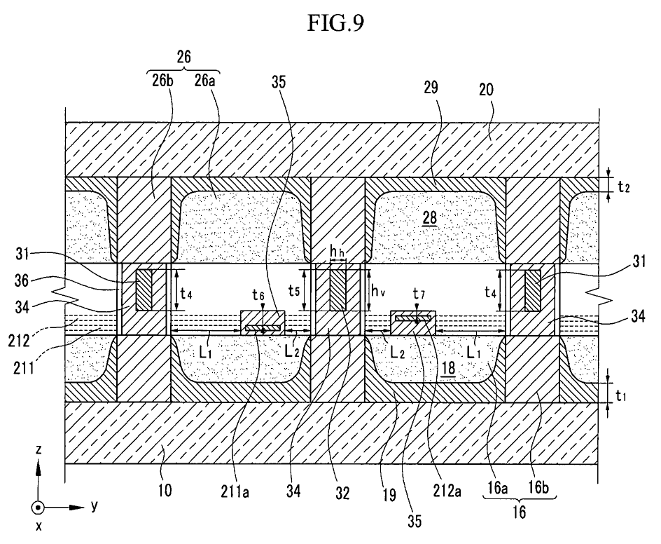

FIG. 9 shows a second embodiment of the present invention. In the second embodiment, a distance L₂ between each of protruding portions 211a and 212a of first and second address electrodes 211 and 212 and the scan electrode 32 is set smaller than a distance L₁ between each of the protruding portions 211a and 212a and the sustain electrode 31. Therefore, triggering is performed by the protruding portions 211a and 212a between the first address electrode 211 and the scan electrode 32, and between the second address electrode 212 and the scan electrode 32, which facilitates the address discharge.

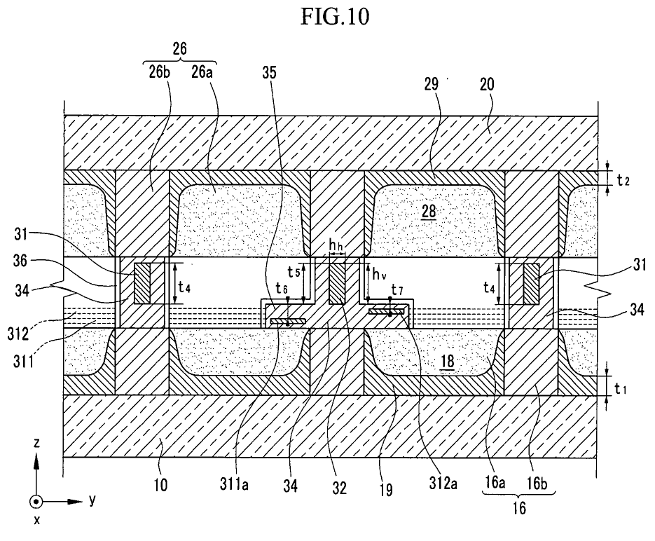

FIG. 10 shows a third embodiment of the present invention. The dielectric layer 35 formed on the outer surface of each of protruding portions 311a and 312a of the first address electrodes 311 and the second address electrodes 312 is directly connected to the dielectric layer 34 provided on the outer surface of the scan electrode 32. Therefore, triggering is performed by the protruding portions 311a and 312a between the first address electrode 311 and the scan electrode 32, and between the second address electrode 312 and the scan electrode 32, which further facilitates the address discharge, as compared with the second embodiment.

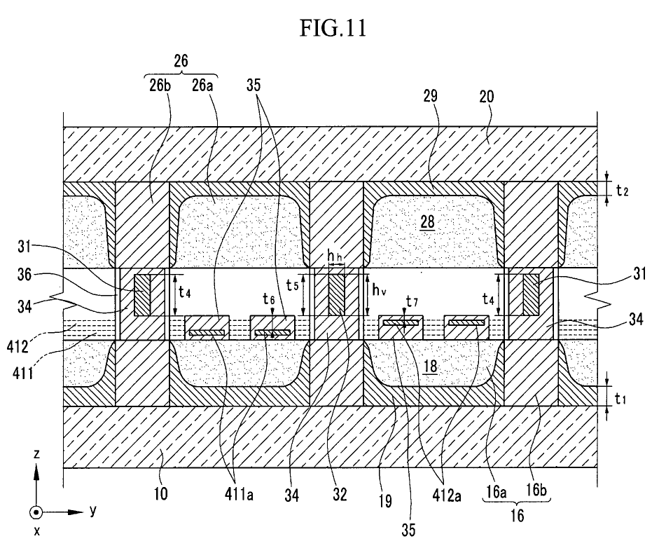

FIG. 11 shows a fourth embodiment of the present invention. A plurality of protruding portions 411a and 412a of each of first address electrodes 411 and second address electrodes 412 can be provided between the sustain electrode 31 and the scan electrode 32. The plurality of protruding portions 411a and 412a function as trigger electrodes in the address discharge period, and thus the sustain discharge between the sustain electrodes 31 and the scan electrodes 32 can be further facilitated. The number of the protruding portions 411a provided adjacent to either of the rear-substrate-side barrier rib 16 and the front-substrate-side barrier rib 26, and the number of the protruding portions 412a provided adjacent to the sustain electrodes 31 and the scan electrodes 32 are the same, for example, two.

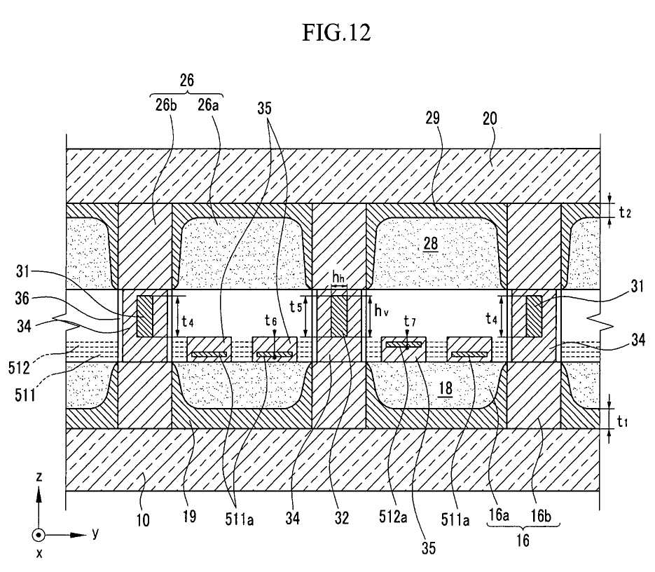

FIG. 12 shows a fifth embodiment of the present invention. In the fifth embodiment, the number of protruding portions 511a and 512a provided adjacent to either one of the rear-substrate-side barrier rib 16 and the front-substrate-side barrier rib 26 is set to be different from the number of the protruding portions 511a and 512a provided adjacent to the sustain electrodes 31 and the scan electrodes 32. That is, in one of a pair of adjacent discharge cells 17 in the y-axis direction, one protruding portion 512a of the second address electrode 512 is provided adjacent to the scan electrode 32, and one protruding portion 511a of the first address electrode 511 is provided adjacent to the sustain electrode 31. In the other discharge cell of the pair of adjacent discharge cells 17 in the y-axis direction, however, the protruding portions 511a of the first address electrode 511 are correspondingly provided adjacent to the sustain electrode 31 and the scan electrode 32.

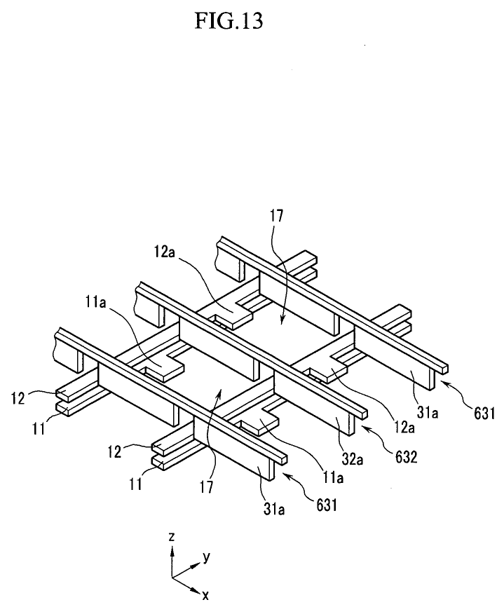

FIG. 13 is a partial perspective view schematically showing structures of the electrodes in a plasma display panel according to a sixth embodiment of the present invention.

In the sixth embodiment, sustain electrodes 631 and the scan electrodes 632 are provided with expanding portions 31a and 32a. The expanding portions 31a and 32a extend toward the rear substrate (in a negative z-axis direction) from the sustain electrodes 631 and the scan electrodes 632 within their respective discharge cell 17.

Each of cross sections of the expanding portions 31a and 32a is formed such that the length of a perpendicular direction (z-axis direction) is set longer than that of a horizontal direction (y-axis direction). With the expanding portions 31a and 32a, the opposing discharge can be further facilitated. In addition, the opposing discharge formed over a wide area in such a manner generates strong vacuum ultraviolet rays. The strong vacuum ultraviolet rays collide against the phosphor layers inside the discharge cells 17, such that the resultant amount of visible light can be increased.

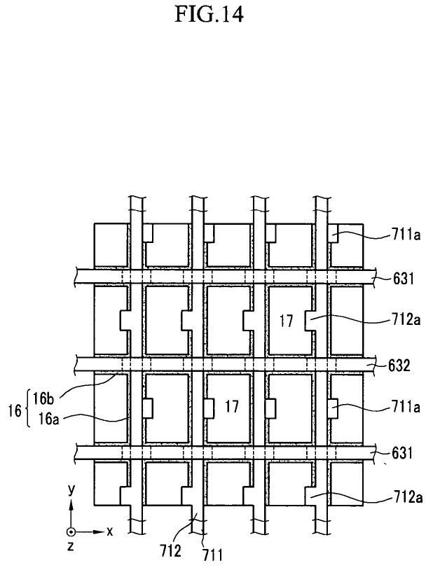

FIGS. 14 to 16 show seventh to ninth embodiments of the present invention. The seventh to ninth embodiments have some parts that are similar to the configuration of the sixth embodiment. Here, only parts that are different from the sixth embodiment will be described.

FIG. 14 is a partial plan view of a plasma display panel according to a seventh embodiment of the present invention. In the present embodiment, protruding portions 711a of the first address electrodes 711 and protruding portions 712a of the second address electrodes 712 alternately protrude toward the centers of the respective discharge cells 17 on two different sides of the discharge cells 17. For example, if a protruding portion 711a is located on the right side of one discharge cell 17, the protruding portion 712a would be located on the left side in another discharge cell 17 that is adjacent to the first discharge cell 17 along the y-axis direction. The y-axis direction in this case is the direction of the address electrodes 711 and 712.

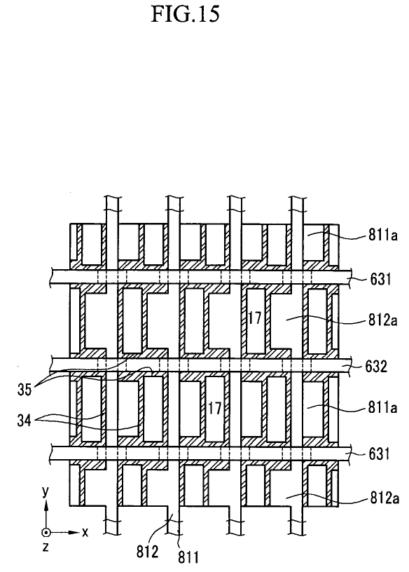

FIG. 15 is a partial plan view of a plasma display panel according to an eighth embodiment of the present invention. The first address electrodes 811 and the second address electrodes 812 are located in the same manner as the seventh embodiment. Each of the protruding portions 811a and 812a is formed larger in width than those of the seventh embodiment. Therefore, the dielectric layer 35 formed on the outer surface of each of the protruding portions 811a and 812a of the first address electrodes 811 and the second address electrodes 812 merges with the dielectric layer 34 provided on the outer surface of the scan electrode 632. Therefore, triggering is performed by each of the protruding portions 811a and 812a between the first address electrode 811 and the scan electrode 632, and between the second address electrode 812 and the scan electrode 632, which further facilitates the address discharge, as compared to the seventh embodiment.

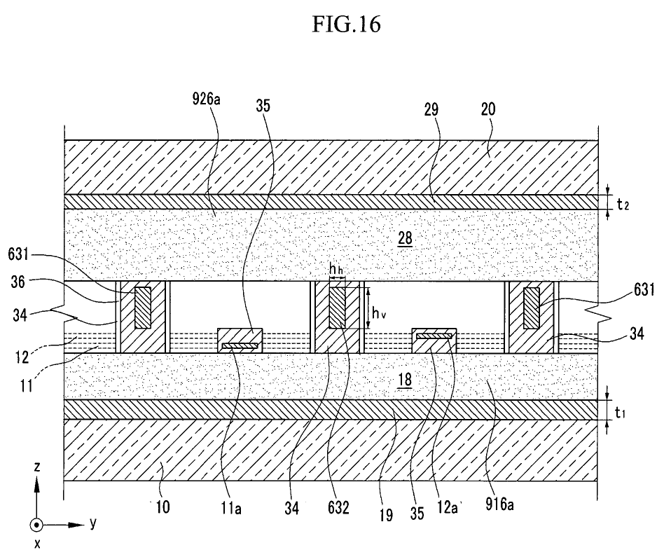

FIG. 16 is a partial cross-sectional view of a plasma display panel according to a ninth embodiment of the present invention. Here, the rear-substrate-side barrier rib has first barrier rib members 916a formed in parallel with the first and second address electrodes 11 and 12 (the y-axis direction) and the front-substrate-side barrier rib has third barrier rib members 926a formed in parallel with the first and second address electrodes 11 and 12 corresponding to the first barrier rib members 16a. That is, in the ninth embodiment, the rear-substrate-side barrier rib and the front-substrate-side barrier rib are formed to have a striped barrier rib structures.

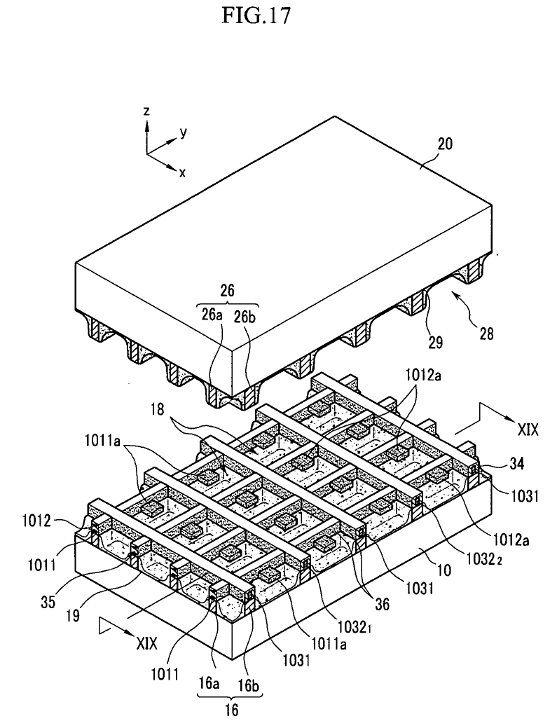

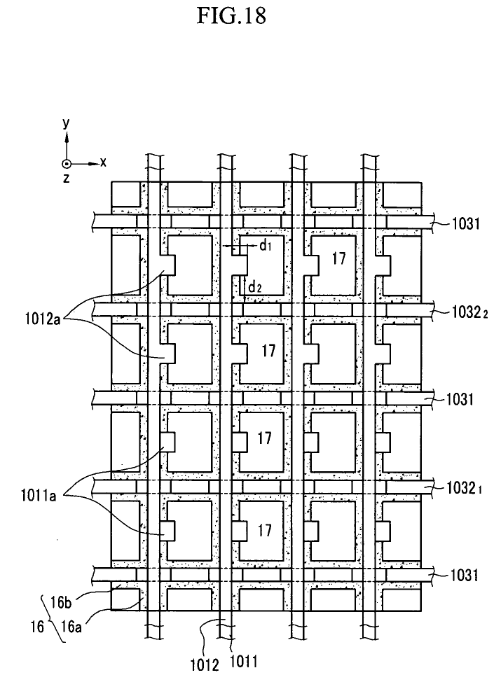

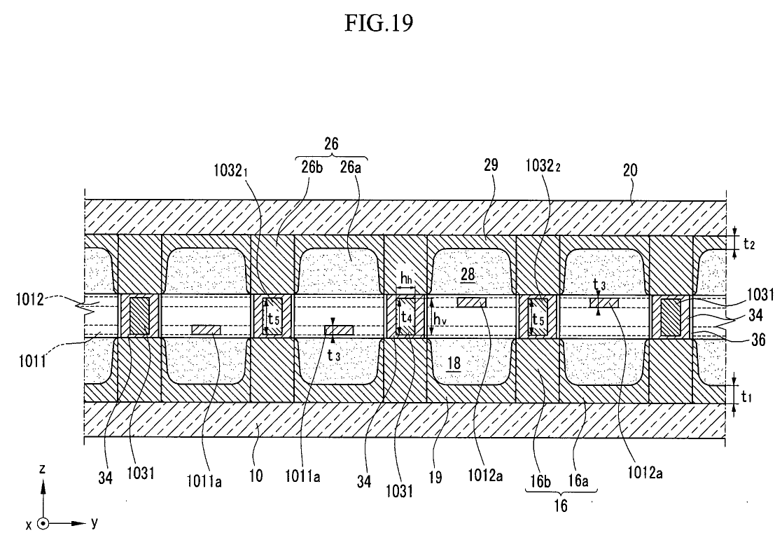

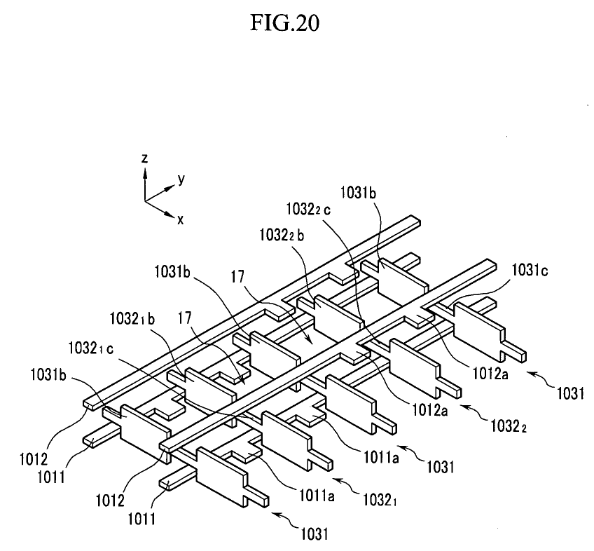

FIG. 17 is a partial exploded perspective view of a plasma display panel according to a tenth embodiment of the present invention. FIG. 18 is a partial plan view schematically showing structures of the electrodes and the discharge cells in the plasma display panel according to the tenth embodiment of the present invention. FIG. 19 is a partial cross-sectional view taken along the line XIX-XIX of FIG. 17 in a state in which the plasma display panel is assembled. FIG. 20 is a partial perspective view schematically showing structures of the electrodes in the plasma display panel according to the tenth embodiment of the present invention.

Referring to FIGS. 17-20, sustain electrodes 1031 and scan electrodes 1032₁ and 1032₂ are formed between the rear-substrate-side barrier ribs 16 and the front-substrate-side barrier ribs 26 to extend in the x-axis direction. Further, the sustain electrodes 1031 and the scan electrodes 1032₁ and 1032₂ are alternately located at the boundaries of adjacent discharge cells 17 in the y-axis direction and are shared by adjacent discharge cells 17. The order of the sustain and scan electrodes is such that a sustain electrode 1031 is adjacent to a scan electrode 1032₁ on one side and to a scan electrode 1032₂ on the other side.

First address electrodes 1011 and second address electrodes 1012 are formed between the rear-substrate-side barrier ribs 16 and the front-substrate-side barrier ribs 26 to extend in the y-axis direction. In addition, the first address electrodes 1011 and second address electrodes 1012 are spaced apart from each other in a direction perpendicular to the substrates. The first address electrodes 1011 have protruding portions 1011a that protrude between the sustain electrodes 1031 and the scan electrodes 1032₁ (on both sides of the scan electrodes 1032₁) provided in one of adjacent discharge cells 17 in the y-axis direction. The second address electrodes 1012 have protruding portions 1012a that protrude between the sustain electrodes 1031 and the scan electrodes 1032₂ (on both sides of the scan electrodes 1032₂) provided in the other discharge cells 17 in the y-axis direction.

In a set of four adjacent discharge cells 17 located along the y-axis directon, the first address electrodes 1011 serve to address two adjacent discharge cells 17, and the second address electrodes 1012 serve to address the other two adjacent discharge cells 17. The first address electrodes 1011 and the second address electrodes 1012 serve to address pairs of the discharge cells 17 located in the y-axis direction alternately.

Because the first address electrodes 1011 are provided adjacent to the rear substrate 10, the protruding portions 1011a protrude into the first discharge spaces 18 on the rear substrate 10. Similarly, because the second address electrodes 1012 are provided adjacent to the front substrate 20, the protruding portions 1012a protrude into the second discharge spaces 28 on the front substrate 20.

In a set of discharge cells having the discharge cells 17 located continuously along a row, there may be various methods of addressing the discharge cells 17 on one side of a sustain electrode 1031 and the discharge cells 17 on the other side. In the present embodiment, the configuration in which the protruding portions 1011a of the first address electrodes 1011 are located on both sides of the scan electrodes 1032₁ provided in discharge cells 17 on one side of the sustain electrode 1031, and the protruding portions 1012a of the second address electrodes 1012 are located on both sides of the scan electrodes 1032₂ provided in discharge cells 17 on the other side of the sustain electrode 1031, is exemplified.

The protruding portions 1011a of the first address electrodes 1011 are formed to protrude toward the centers of the respective discharge cells 17 while corresponding to a group of odd-numbered and to a group of even-numbered discharge cells 17 on one side, and the protruding portions 1012a of the second address electrodes 1012 are formed to protrude toward the centers of the respective discharge cells 17 while corresponding to a group of odd-numbered and to a group of even-numbered discharge cells 17 on the other side. The protruding portions 1011a and the protruding portions 1012a are alternately located in pairs in one set of discharge cells 17 continuously located in the y-axis direction.

Because each of the protruding portions 1011a and 1012a protrudes toward the center of each of the discharge cells 17, the protruding portions 1011a and 1012a may be made the same as the transparent electrodes or may be made of the same materials as those of the first and second address electrodes 1011 and 1012.

On the other hand, in one set of discharge cells 17 continuously located in the y-axis direction, when the scan pulse is applied to the scan electrode 1032₁ on one side, and when the address pulse is applied to the first address electrode 1011, double addressing is realized by one scan operation. Further, when the scan pulse is applied to the scan electrode 1032₂ on the other side, and when the address pulse is applied to the second address electrode 1012, double addressing is realized by one scan operation. In addition, in the one set of discharge cells 17, when the same voltage pulse is applied to two scan electrodes 1032₁ and 1032_{2,} and when the address pulses are applied to the first and second address electrodes 1011 and 1012, quadruple addressing is realized by one scan operation.

Quadruple addressing for selecting adjacent four discharge cells 17 is realized by one scan operation, thereby reducing the address period. In addition, when the reset pulses are applied to both scan electrodes 1032₁ and 1032₂, two discharge cells 17 sharing the scan electrode 1032₁ and two discharge cells 17 sharing the electrode 1032₂ are reset, and thus the reset period is reduced. As such, because the reset period and the address period are reduced, the sustain period can be increased. With the increase of the sustain period, the number of sustain pulses is increased, thereby enhancing power of gray-scale representation. Further, a discharge gap between the scan electrodes 1032₁ and 1032₂ and the address electrodes 1011 and 1012 in the discharge cell 17 is formed as a short gap by each of the protruding portions 1011a and 1012a, such that an address discharge voltage can be further reduced.

Referring to FIG. 20, in order to induce the opposing discharge over a wider area of an opposite surface, the sustain electrodes 1031 include expanding portions 1031b and narrow portions 1031c, and the scan electrodes 1032₁ and 1032₂ include expanding portions 1032₁b, and 1032₂b and narrow portions 1032₁c, and 1032₂c, respectively. The expanding portions 1031b, 1032₁b, and 1032₂b extend in a direction (z-axis direction) perpendicular to the surfaces of the substrates 10, 20, while corresponding to the respective discharge cells 17. The narrow portions 1031c, 1032₁c, and 1032₂c are formed narrower in the dimension along the z-axis direction than those of the expanding portions 1031b, 1032₁b, and 1032₂b, and correspond to the boundaries of the discharge cells 17 adjacent along the x-axis direction. Therefore, the expanding portions 1031b are located to face the expanding portions 1032₁b, and 1032₂b on the two sides with the discharge cells 17 interposed therebetween.

In addition, the sustain electrodes 1031 and the scan electrodes 1032₁ and 1032₂ are formed to extend in a direction intersecting the direction of the first and second address electrodes 1011 and 1012, and include the expanding portions 1031b, 1032₁b, and 1032₂b which correspond to the discharge cells 17. Therefore, the sustain electrodes 1031 and the scan electrodes 1032₁ and 1032₂ can be located to intersect the direction of the address electrodes 1011 and 1012 without interference.

Further, the expanding portions 1031b, 1032₁b, and 1032₂b have cross-sectional structures, in which a vertical length hᵥ in the z-axis direction is longer than a horizontal length hₕ in the y-axis direction. The opposing discharge formed over a wider area in the expanding portions 1031b, 1032₁b, and 1032₂b generates strong vacuum ultraviolet rays. The strong vacuum ultraviolet rays collide against the first and second phosphor layers 19 and 29 over a wide area, such that the resultant amount of visible light to be generated inside the discharge cells 17 can be increased.

In addition, the thickness t₃ of each of the protruding portions 1011a and 1012a of the first and second address electrodes 1011 and 1012 to be measured in a direction (z-axis direction) perpendicular to the rear substrate 10 and the front substrate 20 is formed smaller than the thickness t₄ of each of the sustain electrodes 1031 and the thickness t₅ of each of the scan electrodes 1032₁ and 1032₂. In such a manner, the sustain discharge between the sustain electrodes 1031 and the scan electrodes 1032₁ and 1032₂ is not hindered by the protruding portions 1011a and 1012a of the first and second address electrodes 1011 and 1012, thereby enhancing luminescence efficiency.

Referring to FIG. 18, each of the protruding portions 1011a and 1012a of the first and second address electrodes 1011 and 1012 is, in one embodiment, formed to have a distance d₁ protruding inside the discharge cell 17 larger than zero (d₁>0), such that two of four adjacent discharge cells 17 can be selected by the address pulses applied to the first and second address electrodes 1011 and 1012 and the scan pulse applied to the scan electrode 32.

Further, for the opposing discharge between the first and second address electrodes 1011 and 1012 and the scan electrode 1032₁ and 1032₂, the distance d₂, in the y-axis direction, between each of the protruding portions 1011a and 1012a of the first and second address electrodes 1011 and 1012 and the scan electrode 1032₁ and 1032₂ is, in one embodiment, larger than zero.

The respective protruding portions 1011a and 1012a are correspondingly located at the centers of the discharge cells 17. Therefore, the electrode arrangement of the sustain electrode 1031, the scan electrode 1032₁, the sustain electrode 1031, and the scan electrode 1032₂, along the y-axis direction, is substantially made in an order of the sustain electrode 1031, the protruding portion 1011a of the first address electrode 1011, the scan electrode 1032₁, the protruding portion 1011a of the first address electrode 1011, the sustain electrode 1031, the protruding portion 1012a of the second address electrode 1012, the scan electrode 1032₂, the protruding portion 1012a of the second address electrode 1012, and the sustain electrode 1031.

A method of driving a PDP having the above-described configuration is as follows. The method of driving a PDP includes, in the address period, applying a scan pulse V_{sc} to a scan electrode 1032₁ which is shared by discharge cells 17 on one side among a predetermined number of discharge cells 17, and to a scan electrode 1032₂ which is shared by discharge cells 17 on the other side, and addressing the discharge cells 17 on both sides, to which the scan pulse V_{sc} is applied.

In the addressing, the discharge cells 17 on one side of a sustain electrode 1031 among the predetermined number of discharge cells 17 that share the same sustain electrode 1031 are addressed by the address pulse applied to the first address electrode 1011, and the discharge cells 17 on the other side are addressed by the address pulse applied to the second address electrode 1012.

In a resetting before the above-described scanning and addressing, a reset pulse is applied to two scan electrodes 1032₁ and 1032₂, such that a set of four discharge cells 17, adjacent along the y-axis direction, are simultaneously reset through the interaction of the two scan electrodes 1032₁ and 1032₂ and the sustain electrodes 1031 provided on both sides of the scan electrode 1032₁ and 1032₂. As the reset pulse to be applied in the reset period, a pulse having a known waveform can be used. Further, as the sustain pulse Vₛ to be applied in the sustain period, a pulse having a known waveform can be used.

Hereinafter, eleventh and twelfth embodiments will be described. The eleventh and twelfth embodiments have some similarities to the configuration of the tenth embodiment. Here, the detailed descriptions of the similar parts will be omitted, and only different parts will be described.

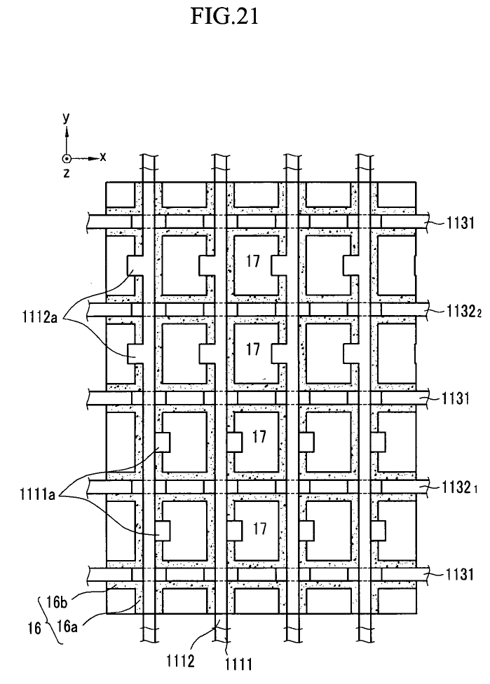

FIG. 21 shows the eleventh embodiment of the present invention.

In the eleventh embodiment, the protruding portions 1111a of the first address electrodes 1111 and the protruding portions 1112a of the second address electrodes 1112 are formed on both sides of the discharge cells, respectively. The protruding portions 1111a of the first address electrodes 1111 and the protruding portions 1112a of the second address electrodes 1112 are alternately located in pairs along the y-axis direction. In addition, the protruding portions 1111a and the protruding portions 1112a protrude toward the centers of the respective discharge cells 17 in the x-axis direction and from different sides of the discharge cells 17.

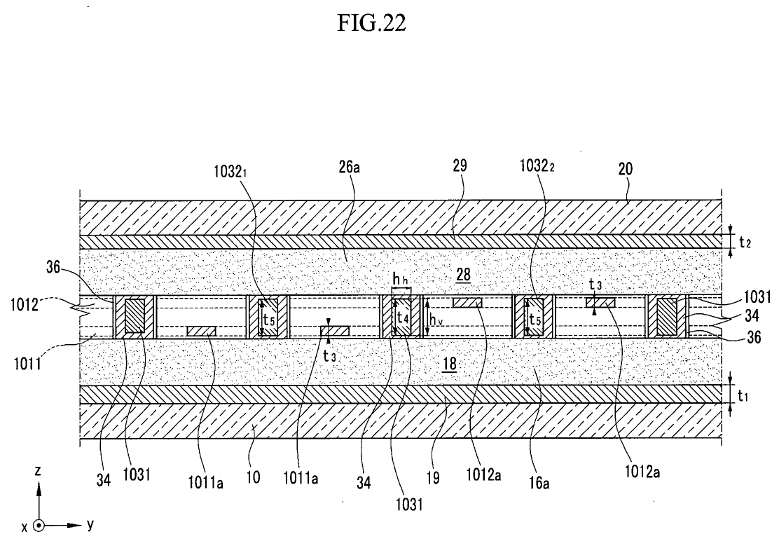

FIG. 22 shows the twelfth embodiment of the present invention. Here, the rear-substrate-side barrier rib 16 has the first barrier rib members 16a formed in parallel with first and second address electrodes 1011 and 1012, and the front-substrate-side barrier rib 26 has the third barrier rib members 26a formed in parallel with the first and second address electrodes 1011 and 1012. Therefore, the first discharge spaces 18 and the second discharge spaces 28 are formed to have stripe shapes which continuously extend in the extension directions (y-axis direction) of the first and second address electrodes 1011 and 1012.

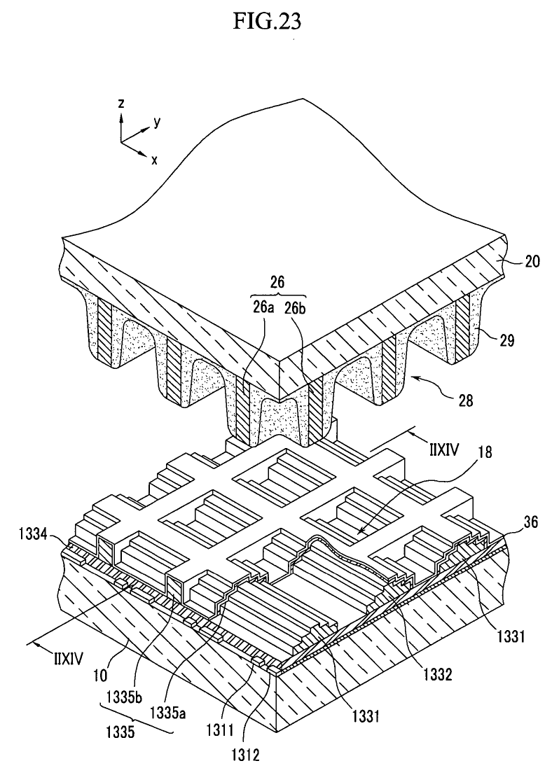

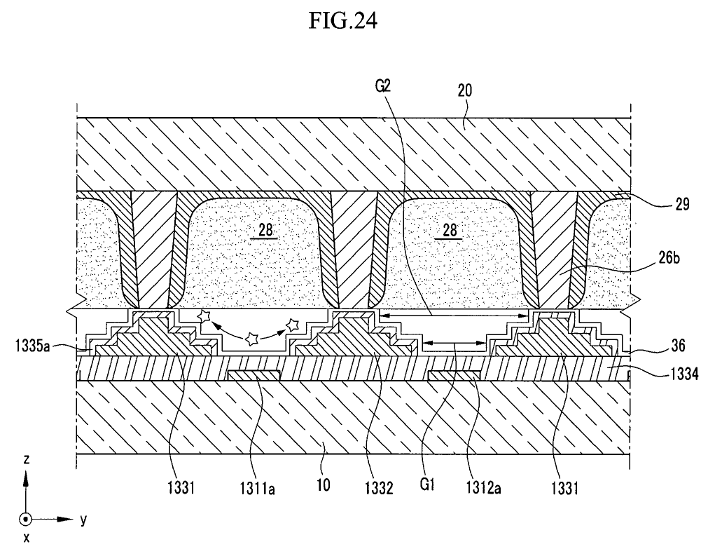

FIG. 23 is a partial exploded perspective view of a plasma display panel according to a thirteenth embodiment of the present invention. FIG. 24 is a partial cross-sectional view taken along the line IIXIV-IIXIV of FIG. 23 in a state in which the plasma display panel is assembled.

Referring to FIGS. 23 and 24, first address electrodes 1311 and second address electrodes 1312 are formed in the y-axis direction indicated in the drawings on the inner surface of the rear substrate 10. The first address electrodes 1311 and the second address electrodes 1312 are located in parallel with each other inside the respective discharge cells 17. The first address electrodes 1311 and the second address electrodes 1312 are involved in addressing of a pair of discharge cells 17 adjacent in the y-axis direction. Because the first address electrodes 1311 and the second address electrodes 1312 are provided adjacent to the rear substrate 10, transmittance of visible light by a discharge is not lowered. Therefore, the first address electrodes 1311 and the second address electrodes 1312 are, in one embodiment, made of a metal having superior conductivity.

A first dielectric layer 1334 is formed on the entire surface of the rear substrate 10 while covering the first address electrodes 1311 and the second electrodes 1312. Display electrodes 1331 and 1332 are formed on the first dielectric layer 1334. The display electrodes 1311 and 1332 are formed to extend in a direction intersecting the first address electrodes 1311 and the second address electrodes 1312. In addition, the display electrodes 1331 and 1332 are formed to be electrically isolated from the first address electrodes 1311 and the second address electrodes 1312. The display electrodes 1331 and 1332 include sustain electrodes 1331 and scan electrodes 1332, and the sustain electrodes 1331 and the scan electrodes 1332 are formed to have stripe shapes on both sides of the respective discharge cells.

In the present embodiment, the sustain electrode 1331 and the scan electrode 1332 are shared by discharge cells 17 that are adjacent in the y-axis direction and are involved in the sustain discharge of discharge cells 17 adjacent in the y-axis direction.

On the other hand, in the present embodiment, all of the electrodes 1311, 1312,1331, and 1332 involved in the discharge are formed on the rear substrate. That is, in the present embodiment, a path for the address discharge can be reduced, as compared with a conventional plasma display panel in which electrodes involved in the address discharge are formed on different substrates, such that a voltage required for the address discharge can be reduced. In addition, because transmittance of visible light is not hindered by the electrodes, the transmittance of visible light is enhanced. Therefore, the electrodes involved in a discharge can be made of a metal having superior conductivity.

The sustain electrodes 1331 and the scan electrodes 1332 protrude further inside the discharge cells 17 in a region close to the rear substrate 10 than in a region close to the front substrate 20. Therefore, the width of each of the sustain electrodes 1331 and the scan electrodes 1332 measured along the y-axis direction indicated in the drawings is formed to be larger in the region close to the rear substrate 10 than in the region close to the front substrate 20.

The width of each of the sustain electrodes 1331 and the scan electrodes 1332 measured along the y-axis direction indicated in the drawings can become larger in steps from the region close the front substrate 20 toward the region close to the rear substrate 10. Therefore, the sustain electrodes 1331 and the scan electrodes 1332 may have cross-sectional structures in which the width of each of the sustain electrodes 1331 and the scan electrodes 1332 becomes larger in steps from the region close to the front substrate 20 toward the region close to the rear substrate 10.

The discharge gap between the sustain electrodes 1331 and the scan electrodes 1332 is formed as a short gap G1 in the region close to the rear substrate 10, and is formed as a long gap G2 in the region close to the front substrate 20 (see FIG. 24). Therefore, a discharge is fired in the short gap G1 of the region close to the rear substrate 10, and then the discharge is dispersed to the long gap G2 in the region close to the rear substrate 10.

That is, because the discharge is fired in the short gap G1 of the region close to the rear substrate 10, the discharge firing voltage can be reduced. Further, because a main discharge is generated in the region close to the front substrate 20, discharge efficiency can be enhanced. In addition, the amount of current flowing in each electrode becomes larger as the area of each electrode becomes larger. Therefore, the electrodes formed in the region close to the front substrate 20 are not involved in firing the discharge, and thus the amount of discharge current can be reduced by decreasing the area of each electrode formed in the region close to the front substrate 20.

Even though the sustain electrodes 1331 and the scan electrodes 1332 are formed to have three-step structures in the exemplary embodiment shown, the present invention is not limited to this structure as long as the electrodes are formed to have two or more step structures. In addition, the number of steps constituting the step structures of the sustain electrodes 1331 and the scan electrodes 1332 may be different. This also falls within the scope of the present invention.

The sustain electrodes 1331 and the scan electrodes 1332 having these structures can be easily formed by methods such as a printing method or the like.

A second dielectric layer 1335 is formed to surround the sustain electrodes 1331 and the scan electrodes 1332. Returning to FIG. 23, in the present embodiment, the second dielectric layer 1335 includes a first dielectric layer portion 1335a and a second dielectric layer portion 1335b. The first dielectric layer portion 1335a is formed in the x-axis direction while surrounding the sustain electrodes 1331 and the scan electrodes 1332. The second dielectric layer portion 1335b is formed in a direction (y-axis direction of the drawing) intersecting the first dielectric layer portion 1335a along the edge of each discharge cell 17.

The second dielectric layer 1335 insulates the sustain electrodes 1331 and the scan electrodes 1332, and wall charges caused by the discharge can be accumulated on the second dielectric layer 1335. In addition, the second dielectric layer portion 1335b of the second dielectric layer 1335 serves to isolate the first discharge space 18 as an independent space.

The protective film 36 made of an MgOₓ is formed on the entire surface of the rear substrate 10 while covering the first dielectric layer 1334 and the second dielectric layer 1335.

In the present embodiment, the electrodes involved in the address discharge are formed on the rear substrate 10, and the phosphor layer 29 is formed on the front substrate 20. In such a manner, the discharge firing voltage of the address discharge is the same in the discharge cells which realize red, green, and blue colors. In the related art, phosphor layers are formed between the electrodes which generate the address discharge, and dielectric constants of the phosphor layers of red, green, and blue colors are different from one another. Therefore, there was a problem that the discharge firing voltage of the address discharge is different according to colors. However, the plasma display panel according to the present embodiment can prevent such a problem.

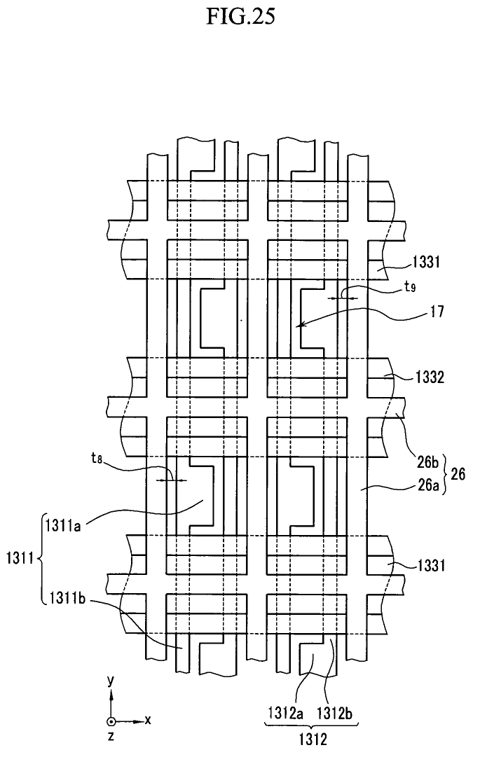

Hereinafter, the first address electrodes 1311 and the second address electrodes 1312 according to the present embodiment will be described in detail with reference to FIG. 25. FIG. 25 is a partial plan view schematically showing the plasma display panel according to the thirteenth embodiment of the present invention.

As described above, the first address electrodes 1311 and the second address electrodes 1312 alternately are involved in addressing of a pair of discharge cells 17 that are adjacent in the y-axis direction. To this end, in one discharge cell 17 of the pair of adjacent discharge cells 17, the area of the corresponding first address electrode 1311 is formed smaller than the area of the corresponding second address electrode 1312. Further, in the other discharge cell 17 of the pair of adjacent discharge cells 17, the area of the corresponding first address electrode 1311 is formed larger than the area of the corresponding second address electrode 1312. The larger the area of the electrode involving in addressing is, the lower the voltage required for addressing will be, and thus the address electrodes 1311 and 1312 having a larger area in each discharge cell 17 are involved in addressing of the corresponding discharge cell 17.

In view of the difference in area, the first address electrodes 1311 and the second address electrodes 1312 include first portions 1311a and 1312a and second portions 1311b and 1312b, respectively. The first portions 1311a and 1312a correspond to spaces between the sustain electrodes 1331 and the scan electrodes 1332 in the respective discharge cells 17 while protruding inside the discharge cells 17. The second portions 1311b and 1312b are portions that connect the first portions 1311a and 1312a along the y-axis direction.

The first portions 1311a and 1312a are alternately and symmetrically located with respect to the scan electrodes 1332 in a pair of discharge cells 17 adjacent in the y-axis direction. The edge of each of the first portions 1311a and 1312a at an edge of the discharge cell 17 is substantially formed in parallel with the edge of each of the discharge cells 17 by a constant distance t₈ and t₉, respectively, and the first portions 1311a and 1312a protrude toward opposite directions from each other.

Accordingly, when the scan pulse is applied to the scan electrode 1332, and when the address pulse is applied to the first and second address electrodes 1311 and 1312, a pair of discharge cells 17 that share the scan electrode 1332 are addressed. That is, a pair of discharge cells 17 that share the scan electrode 1332 can be addressed by one scan operation, and thus the address period is reduced. In the same manner, when the reset pulse is applied to the scan electrodes 1332, a pair of discharge cells 17 which share the scan electrode 1332 can be reset by one reset pulse, and thus the reset period is reduced.

As such, because the reset period and the address period are reduced, the sustain period can be increased. With the increase of the sustain period, the power of gray-scale representation can be enhanced and overall luminance can be enhanced.

In addition, by causing a current flowing in the first address electrodes 1311 and a current flowing in the second address electrodes 1312 to flow in opposite directions, electromagnetic interference (EMI) can be reduced.

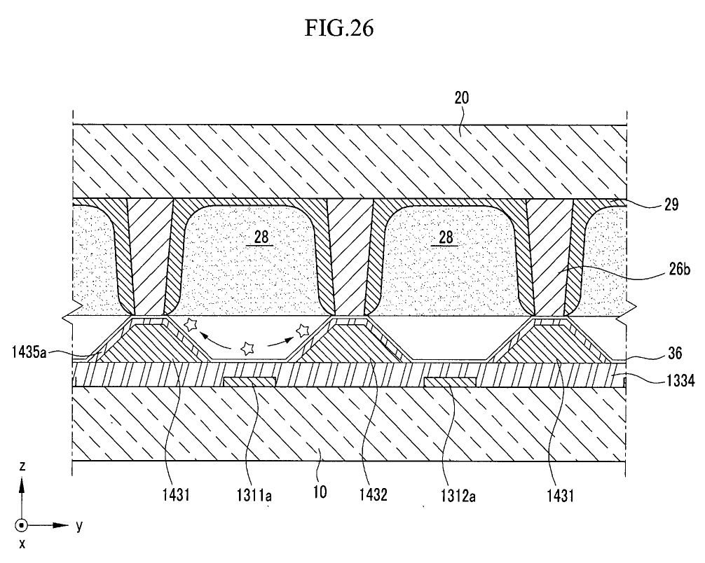

FIG. 26 is a partial cross-sectional view of a plasma display panel according to a fourteenth embodiment of the present invention.

Referring to FIG. 26, sustain electrodes 1431 and scan electrodes 1432 are formed to have spaces therebetween and to face each other. The width of each of the sustain electrodes 1431 and the scan electrodes 1432 measured along the y-axis direction indicated in the drawing can become gradually larger from the region close to the front substrate 20 toward the region close to the rear substrate 10.

That is, in the present embodiment, a discharge gap between the sustain electrode 1431 and the scan electrode 1432 becomes gradually larger from the region close to the rear substrate 10 toward the region close to the front substrate 20. Therefore, the discharge fired in the short gap in the region close to the rear substrate 10 is easily dispersed to the long gap in the region close to the front substrate 20. Therefore, the discharge firing voltage is reduced by the short discharge gap, and discharge efficiency is enhanced by the long discharge gap, thereby ensuring discharge stability.

A second dielectric layer 1435 includes a first dielectric layer portion 1435a formed to surround the sustain electrodes 1431 and the scan electrodes 1432, and a second dielectric layer portion 1435b formed in a direction intersecting the direction of the first dielectric layer portion 1435a. At this time, an opposite surface that faces the first dielectric layer portion 1435a inside each discharge cell 17 is formed to correspond to the shape of each of the sustain electrodes 1431 and the scan electrodes 1432.

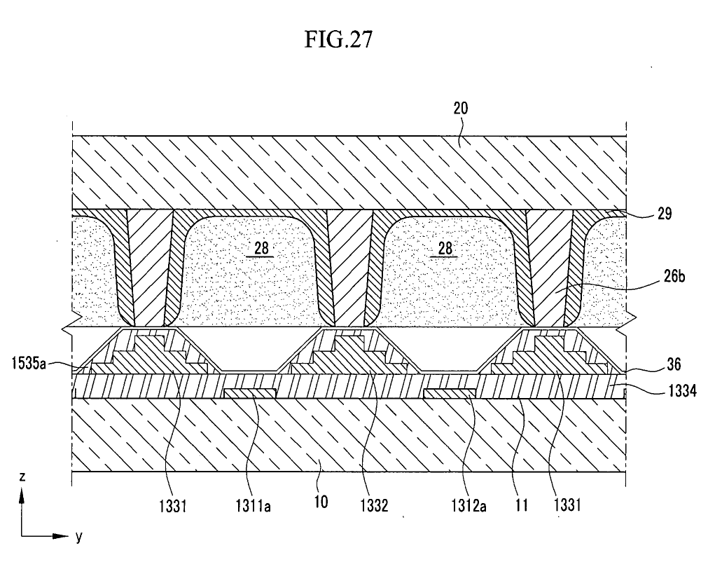

FIG. 27 is a partial cross-sectional view of a plasma display panel according to a fifteenth embodiment of the present invention.

In the fifteenth embodiment, the sustain electrodes 1331 and the scan electrodes 1332 protrude inside the discharge cells 17 in steps toward the front substrate 20. A second dielectric layer 1535 which forms an insulated structure of the sustain electrodes 1331 and the scan electrodes 1332 is formed. The second dielectric layer 1535 includes a first dielectric layer portion 1535a and a second dielectric layer portion 1535b. The first dielectric layer portion 1535a is formed to surround the sustain electrodes 1331 and the scan electrodes 1332. The second dielectric layer portion 1535b is formed in a direction intersecting the direction of the first dielectric layer portion 1535a.

Referring to FIG. 27, in the fifteenth embodiment, the first dielectric layer portion 1535a of the second dielectric layer 1535 gradually protrude inside the discharge cells 17 from the rear substrate 20 toward the front substrate 20.

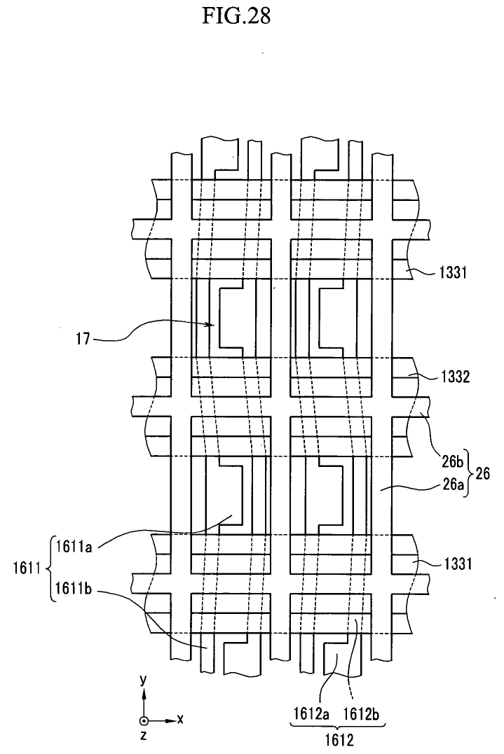

FIG. 28 is a partial plan view of a plasma display panel according to a sixteenth embodiment of the present invention.

Referring to FIG. 28, in the sixteenth embodiment, first and second address electrodes 1611 and 1612 are formed inclined further toward the centers of the discharge cells 17 in a region where second portions 1611b and 1612b are formed but not in a region where first portions 1611a and 1612a are formed. With this structure, an opposite area of regions involved in the discharge between the scan electrodes 1332 and the address electrodes 1611 and 1612 can be maximized, and the discharge firing voltage of the address discharge can be reduced.

A driving method of the plasma display panel according to each of the fourteenth to sixteenth embodiments of the present invention is similar to the method driving of the plasma display panel according to the thirteenth embodiment. Therefore, the driving method of the plasma display panel according to each of the fourteenth to sixteenth embodiments will be described on the basis of the driving method of the plasma display panel according to the thirteenth embodiment.

That is, in the addressing period, the method of driving the PDP includes applying the scan pulse to the scan electrode 1332 which is shared by adjacent discharge cells 17, and an addressing the discharge cells 17 to which the scan pulse is applied.

During an addressing period, one of two adjacent discharge cells 17 is addressed by the address pulse applied to the first address electrodes 1311, and the other discharge cell 17 is addressed by the address pulse applied to the second address electrode 1312.

During a resetting period before the above-described scanning and addressing periods, a pair of adjacent discharge cells 17 are simultaneously reset. The reset pulse is applied to one scan electrode 1332, such that the two adjacent discharge cells 17 are simultaneously reset through the interaction of the scan electrode 1332 and the sustain electrodes 1331 provided on two sides of the scan electrode 1332.

As the reset pulse to be applied in the reset period, a pulse having a known waveform can be used. Further, as the sustain pulse to be applied in the sustain period, a pulse having a known waveform can be used.

As described above, according to the plasma display panel of an aspect of the present invention, the electrodes are provided between the rear and front substrates, and, of the electrodes, the sustain electrodes and the scan electrodes are provided to form the opposing discharge structure. In addition, the sustain and scan electrodes which are shared by adjacent discharge cells are alternately located intersecting the direction of the address electrodes. Further, groups of even-numbered discharge cells and odd-numbered discharge cells are simultaneously addressed, and thus the address period is reduced. Further, each scan electrode is shared by a pair of adjacent discharge cells, and the groups of even-numbered and odd-numbered discharge cells are simultaneously reset. Therefore, the reset period can be reduced. As such, with the reduction of the reset period and the address period, the sustain period can be increased, thereby enhancing the power of gray-scale representation.

In addition, according to the plasma display panel of another aspect of the present invention, after the group of odd-numbered discharge cells are addressed by the second address electrodes, the group of even-numbered discharge cells can be addressed by the first address electrodes. In this case, address electrode drivers are configured as one, and thus manufacturing costs can be reduced.

In addition, according to the plasma display panel of still another aspect of the present invention, by using the short discharge gap and the long discharge gap during the sustain discharge, discharge efficiency is enhanced while reducing the discharge firing voltage of the sustain discharge.

In addition, as the scan electrodes, the sustain electrodes, and the address electrodes are formed on the rear substrate, the path for the address discharge can be reduced, such that the discharge firing voltage of the address discharge can be further reduced. As a result, the address discharge becomes stable. Further, by forming the electrodes and the phosphor layers which generate the address discharge on different substrates, the discharge firing voltages of the address discharge can be made equal.

Although exemplary embodiments of the present invention have been described in detail, it should be understood that many variations and/or modifications of the basic inventive concept taught, will fall within the spirit and scope of the present invention, as defined in the appended claims.

What is claimed is:

1. A plasma display panel comprising:
a first substrate and a second substrate facing each other with a predetermined space therebetween, the space being divided into a plurality of discharge cells with phosphor layers formed in the discharge cells;
first electrodes and second electrodes extending in a first direction between the first substrate and the second substrate and alternately located between discharge cells adjacent along a second direction intersecting the first direction; and
first address electrodes and second address electrodes extending along the second direction between the first substrate and the second substrate corresponding to boundaries of discharge cells adjacent along the first direction, the first address electrodes and the second address electrodes having protruding portions protruding in the first direction within corresponding discharge cells.

2. The plasma display panel of claim 1, further comprising:
a first barrier rib layer adjacent to the first substrate for defining a plurality of first discharge spaces; and
a second barrier rib layer adjacent to the second substrate for defining second discharge spaces facing the first discharge spaces,
wherein each of the discharge cells is being formed by a pair of the first discharge spaces and the second discharge spaces facing each other.

3. The plasma display panel of claim 2, wherein each of the second discharge spaces has a larger volume than each of the first discharge spaces.

4. The plasma display panel of claim 2,
wherein the first barrier rib layer has first barrier rib members formed in the second direction and second barrier rib members formed to intersect the first barrier rib members, and
wherein the second barrier rib layer has third barrier rib members formed in the second direction and fourth barrier rib members formed to intersect the third barrier rib members.

5. The plasma display panel of claim 2, wherein the first electrodes, the second electrodes, the first address electrodes, and the second address electrodes are located between the first barrier rib layer and the second barrier rib layer.

6. The plasma display panel of claim 1, wherein dielectric layers are provided on outer surfaces of the first address electrodes and the second address electrodes.

7. The plasma display panel of claim 1, wherein the first address electrodes and the second address electrodes are located on the same side with respect to the first electrodes and the second electrodes in a direction perpendicular to the first substrate.

8. The plasma display panel of claim 7, wherein the first address electrodes are closer than the second address electrodes to the first substrate or to the second substrate and the second address electrodes are closer than the first address electrodes to the first electrodes and to the second electrodes along a distance in the direction perpendicular to the first substrate.

9. The plasma display panel of claim 7,
wherein dielectric layers are provided on outer surfaces of the first address electrodes and the second address electrodes, and
wherein a dielectric layer formed between the protruding portions of the first address electrodes and the second electrodes has a larger thickness than a dielectric layer formed between the protruding portions of the second address electrodes and the second electrodes.

10. The plasma display panel of claim 9, wherein a protective film is provided on outer surfaces of the dielectric layers.

11. The plasma display panel of claim 1, wherein the first address electrodes and the second address electrodes are made of a conductive metal.

12. The plasma display panel of claim 1, wherein each of the protruding portions of the first address electrodes and the protruding portions of the second address electrodes are closer to a corresponding one of the second electrodes than a corresponding one of the first electrodes.

13. The plasma display panel of claim 12, wherein a dielectric layer formed on an outer surface of each of the protruding portions of the first address electrodes is merged with a dielectric layer formed on an outer surface of a corresponding one the protruding portions of the second address electrodes and to a dielectric layer formed on an outer surface of the corresponding one of the second electrodes.

14. The plasma display panel of claim 1, the first address electrodes and the second address electrodes each include a plurality of protruding portions within the discharge cells.

15. The plasma display panel of claim 14,
wherein the protruding portions of the first address electrodes are located closer to either the first substrate or the second substrate than the protruding portions of the second address electrodes,
wherein a distance along a direction perpendicular to the first substrate measured between the protruding portions of the second address electrodes and the first electrodes or the second electrodes is shorter than a same distance measured between the protruding portions of the first address electrodes and the first electrodes or the second electrodes, and
wherein a number of the protruding portions of the first address electrodes inside each one of the discharge cells is different from a number of the protruding portions of the second address electrodes inside each one of the discharge cells.

16. The plasma display panel of claim 1, wherein the first address electrodes and the second address electrodes are each provided with two protruding portions inside each one of the discharge cells.

17. The plasma display panel of claim 15,
wherein the protruding portions of the first address electrodes inside a first discharge cell are provided adjacent to both the first electrode and the second electrode of the first discharge cell,
wherein one protruding portion of the first address electrodes in a second discharge cell adjacent to the first discharge cell along the second direction, is provided adjacent to the first electrode of the second discharge cell, and
wherein one protruding portion of the second address electrodes is provided inside the second discharge cell and adjacent to the second electrode of the second discharge cell.

18. The plasma display panel of claim 1, wherein a third direction is perpendicular to a plane formed by the first direction and the second direction and wherein each of the first electrodes and the second electrodes has a dimension along the third direction longer than a dimension along the second direction.

19. The plasma display panel of claim 1, wherein cross sections of the first electrodes in a plane perpendicular to the first direction are symmetrical with respect to a line in the third direction.

20. The plasma display panel of claim 1, wherein cross sections of the second electrodes in a plane perpendicular to the first direction are symmetrical with respect to a line in the third direction.

21. The plasma display panel of claim 1, wherein the first electrodes and the second electrodes are made of a conductive metal.

22. The plasma display panel of claim 1, wherein dielectric layers are provided on outer surfaces of the first electrodes and the second electrodes.

23. The plasma display panel of claim 22, wherein a protective film is provided on outer surfaces of the dielectric layers.

24. The plasma display panel of claim 1, wherein the phosphor layers have first phosphor layers formed on a first substrate side of the respective discharge cells and second phosphor layers formed on a second substrate side of the respective discharge cells.

25. The plasma display panel of claim 24, wherein the first phosphor layers are made of reflective phosphors, and the second phosphor layers are made of transmissive phosphors.

26. The plasma display panel of claim 24, wherein each of the first phosphor layers has a thickness larger than a thickness of each of the second phosphor layers.

27. The plasma display panel of claim 1, wherein each of the first electrodes and the second electrodes has expanding portions extending in a third direction perpendicular to a surface of the first substrate or the second substrate.

28. The plasma display panel of claim 27, wherein the protruding portions of the first address electrodes and the protruding portions of the second address electrodes protrude inside their respective discharge cells alternately and from opposite sides of the discharge cells.

29. The plasma display panel of claim 27, wherein each of the expanding portions of the first electrodes and the second electrodes has a dimension along third direction larger than a dimension along the second direction.

30. The plasma display panel of claim 27, further comprising:
a first barrier rib layer adjacent to the first substrate for defining a plurality of discharge spaces; and
a second barrier rib layer adjacent to the second substrate for defining discharge spaces facing the discharge spaces defined by the first barrier rib,
wherein the first barrier rib layer has first barrier rib members extending in the second direction, and the second barrier rib layer has third barrier rib members extending in the second direction.

31. A plasma display panel comprising:
a first substrate and a second substrate facing each other with a predetermined gap therebetween, the predetermined gap being divided into a plurality of discharge cells with phosphor layers formed in the discharge cells;
first electrodes and second electrodes extending in a first direction between the first substrate and the second substrate, the first electrodes and the second electrodes being alternately located on boundaries of the discharge cells adjacent along a second direction intersecting the first direction, the first electrodes and the second electrodes extending from the first substrate toward the second substrate in a third direction perpendicular to the first direction; and
first address electrodes and second address electrodes extending in a second direction between the first substrate and the second substrate to correspond to boundaries of the discharge cells adjacent in the first direction,
wherein, in a plurality of discharge cells adjacent along the second direction, the first address electrodes have protruding portions that protrude between the first electrodes and second electrodes on the boundaries of the discharge cells from one side of the discharge cell, and the second address electrodes have protruding portions that protrude between the first electrodes and second electrodes provided in the discharge cells from an opposite side of the discharge cell.

32. The plasma display panel of claim 31, wherein, the first address electrodes are located closer to the first substrate, and the second address electrodes are located closer to the second substrate, the first electrodes and the second electrodes being between the first address electrodes and the second address electrodes.

33. The plasma display panel of claim 31, wherein the first electrodes and the second electrodes have expanding portions and narrow portions, each expanding portion corresponding to one of the discharge cells and perpendicular to the first substrate, each narrow portion corresponding to a boundary between two of the discharge cells adjacent along the first direction, the narrow portions having a dimension in a direction perpendicular to the first substrate narrower than the expanding portions.

34. The plasma display panel of claim 31, wherein the protruding portions of the first address electrodes and the protruding portions of the second address electrodes protrude toward an inside of their respective discharge cells on the same side of the discharge cells.

35. The plasma display panel of claim 31, wherein the protruding portions of the first address electrodes and the protruding portions of the second address electrodes protrude toward an inside of the respective discharge cells on opposite sides of the discharge cells.

36. The plasma display panel of claim 31, further comprising:
a plurality of sub-pixels, each sub-pixel having a plurality of discharge cells.

37. The plasma display panel of claim 36, wherein four discharge cells adjacent along the second direction form one sub-pixel having an electrode arrangement in an order of the first electrode, a first one of the second electrodes, the first electrode, a second one of the second electrodes, and the first electrode.

38. The plasma display panel of claim 37, wherein the first one of the second electrodes is located between the protruding portions of the first address electrodes and the second one of the second electrodes is located between the protruding portions of the second address electrodes.

39. A plasma display panel comprising:
a first substrate and a second substrate facing each other;
a barrier rib defining a plurality of discharge cells at a space between the first substrate and the second substrate with phosphor layers formed in the discharge cells;
first electrodes and second electrodes extending in a first direction between the first substrate and the second substrate; and
first address electrodes and second address electrodes formed on the first substrate and extending in parallel with one another in the second direction.

40. The plasma display panel of claim 39, wherein each of the first address electrodes and the second address electrodes has first portions that protrude inside the respective discharge cells and a second portion that connects the first portions.

41. The plasma display panel of claim 40,
wherein the first portions of the first address electrodes and the first portions of the second address electrodes are located in alternate discharge cells adjacent in the second direction, and
wherein the first portions of the first address electrodes and the first portions of the second address electrodes protrude inside respective discharge cells from opposite sides of the discharge cells.

42. The plasma display panel of claim 40, wherein the first portions of the first address electrodes and the first portions of the second address electrodes are symmetrically located with respect to the first electrodes or the second electrodes.

43. The plasma display panel of claim 39,
wherein the second electrodes are sequentially applied with a scan pulse during an address period for an address discharge, and the first electrodes together with the second electrodes are applied with a sustain voltage during a sustain period so as to be involved in a sustain discharge,
wherein among pairs of discharge cells sharing the second electrodes and adjacent in the second direction, in discharge cells on one side of the shared second electrode, each of the first address electrodes has an area smaller than each of the second address electrodes, and
wherein in discharge cells on the other side, each of the first address electrodes has an area larger than that of each of the second address electrodes.

44. The plasma display panel of claim 39, wherein an edge of each of the first address electrodes and the second address electrodes along the second direction is substantially parallel with an edge of each of the discharge cells along the same direction.

45. The plasma display panel of claim 40, wherein the edge of each of the first address electrodes and the second address electrodes along the second direction is formed closer to a center of each of the discharge cells in the first portions than in the second portions.

46. The plasma display panel of claim 39, wherein at least one of the first electrodes and the second electrodes extends further inside each of the discharge cells in a region close to the first substrate than in a region close to the second substrate.

47. The plasma display panel of claim 46, wherein a width of at least one of the first electrodes and the second electrodes measured along the second direction increases in steps from the region close to the second substrate toward the region close to the first substrate.

48. The plasma display panel of claim 46, wherein a width of at least one of the first electrodes and the second electrodes measured along the second direction gradually increases from the region close to the second substrate toward the region close to the first substrate.

49. The plasma display panel of claim 39, wherein dielectric layers are provided on outer surfaces of the first electrodes and the second electrodes, the dielectric layers including a first dielectric layer portion and a second dielectric layer portion, the first dielectric layer portion being formed in parallel with the first and second electrodes while covering the first electrodes and the second electrodes, and the second dielectric layer portion being formed in a direction intersecting the first dielectric layer portion along an edge of each of the discharge cells.

50. A method of driving a plasma display panel having first electrodes and second electrodes alternately arranged and extending in a first direction between a first substrate and a second substrate facing each other, the first electrodes and the second electrodes being shared by discharge cells adjacent in a second direction intersecting the first direction, the plasma display panel further having first address electrodes and second address electrodes extending in the second direction and being spaced from one another in a direction perpendicular to the first substrate or the second substrate, the method comprising, during an address period:
applying a scan pulse to the second electrode being shared by a first discharge cell and a second discharge cell adjacent to each other in the second direction; and
addressing the first discharge cell and the second discharge cell to which the scan pulse is applied.

51. The method of claim 50, wherein during the addressing of the first discharge cell and the second discharge cell, the first discharge cell is addressed by the first address electrode.

52. The method of claim 50, wherein during the addressing of the first discharge cell and the second discharge cell, the second discharge cell is addressed by the second address electrode.

53. The method of claim 50, wherein during the addressing of the first discharge cell and the second discharge cell, the first discharge cell is addressed by the first address electrode and the second discharge cell is addressed by the second address electrode, addressing by the first address electrode and addressing by the second address electrode being simultaneously performed.

54. The method of claim 53, wherein an address pulse is applied to the first address electrode from a first address electrode driver, and an address pulse is applied to the second address electrode from a second address electrode driver.

55. The method of claim 54, wherein a value of the address pulse applied to either the first address electrode or the second address electrode located close to the second electrode is equal to or less than a value of the address pulse applied to the other.

56. The method of claim 55, wherein the value of the address pulse applied to the second address electrode is equal to or less than the value of the address pulse applied to the first address electrode.

57. The method of claim 50, wherein, in the addressing the first discharge cell and the second discharge cell, the first discharge cell is addressed by the first address electrode and the second discharge cell is addressed by the second address electrode, and addressing by the first address electrode and addressing by the second address electrode are sequentially realized.

58. The method of claim 57, wherein, in the addressing of the first discharge cell and the second discharge cell, the discharge cells in which the distance between the second electrode and the address electrode is large is addressed before the other discharge cell is addressed.

59. The method of claim 57, wherein, in the addressing of the first discharge cell and the second discharge cell, the first discharge cell in which the first address electrode is provided is addressed before the second discharge cell in which the second address electrode is provided.

60. The method of claim 57, wherein an address pulse is applied to the first address electrode from an address electrode driver, and then an address pulse is applied to the second address electrode from the address electrode driver.
